(19) United States
(12) Patent Application Publication
(10) Pub. No.: US 2026/0256333 A1
(43) Pub. Date: Sep. 3, 2026

(54) Autonomous Mobile Robot and Service Station

(71) Applicant: Papst Licensing GmbH & Co. KG, St. Georgen (DE)

(72) Inventors: Michael SCHAHPAR, Leonding (AT); Hubert STREICHER, Leonding (AT); Marc EGGER, Leonding (AT); Harold ARTES, Leonding (AT); Benedikt MUELLER, Leonding (AT); Alexandra RADLAK, Leonding (AT); Dominik SEETHALER, Leonding (AT); Daniel FEHN, Leonding (AT); Astrid BREIN, Leonding (AT); Frederik WENIGWIESER, Leonding (AT); Stefan EGGER, Leonding (AT); Erdwin MASCHER, Leonding (AT)

(73) Assignee: Papst Licensing GmbH & Co. KG, St. Georgen (DE)

(21) Appl. No.: 18/721,802

(22) PCT Filed: Mar. 24, 2022
(86) PCT No.: PCT/EP2022/057822

§ 371 Date: Sep. 19, 2024

(30) Foreign Application Priority Data
Mar. 24, 2021 (DE) 10 2021 107 439.8
Nov. 9, 2021 (DE) 10 2021 129 153.4

(51) Int. Cl. A47L 11/40; B01D 53/26; C02F 1/00; C02F 103/44; G05D 1/222

(52) U.S. Cl. CPC A47L 11/4091; A47L 11/4011; B01D 53/26; C02F 1/008; A47L 2201/024; A47L 2201/026; A47L 2201/028; B01D 2257/80; C02F 2103/44; G05D 1/222

(57) ABSTRACT

The invention relates to a system with a service station for an autonomous mobile robot. According to one embodiment, the system includes the service station having a service parking area for the robot into which the robot can drive from a front side of the service station. The system further includes a tank that is accessible to a user from the front side or connections for an external tank.

### CROSS-REFERENCE TO RELATED APPLICATION

The present application claims the benefit of International Patent Application No. PCT/EP2022/057822, filed Sep. 29, 2022, which claims priority to German Patent Application No. 10 2021 129 153.4, filed Nov. 9, 2021 and German Patent Application No. 10 2021 107 439.8, filed Mar. 24, 2021, the entirety of each of which is incorporated herein by reference.

### TECHNICAL AREA

The description relates to the field of autonomous mobile robots, in particular methods for using the robot and a service station for the robot in order to make it more autonomous and easier to maintain.

### BACKGROUND

Numerous autonomous mobile robots are available for different private or commercial applications, for example the processing or cleaning of floor surfaces (cleaning robots). Many devices also use service stations to reduce the amount of maintenance required. It is currently common for autonomous mobile robots to have a charging station where they can recharge after completing a task so that they are ready for the next task.

Most cleaning robots have a dry cleaning unit. This is primarily designed in such a way that a broom, brush and/or suction device is moved over a floor surface and the part of the floor surface that has been driven over is thereby cleaned.

There are also cleaning robots that have a wet cleaning unit. With such robots, a moistened textile is usually moved over the floor, on or in which the dirt that comes loose from the floor is collected. A combination of dry cleaning devices and wet cleaning devices is now also available. Such devices often have a dry cleaning unit in the front area and a wet cleaning unit in the rear area. In this way, the floors are first swept and vacuumed and treated from the rear part with the wet cleaning unit, whereby the stubborn dirt is loosened with cleaning liquid (e.g. water) and then picked up by the textile.

The disadvantage of using wet cleaning units is that the moisture in the textile is only available for a limited period of time because it is released onto the floor during cleaning and then evaporates. To counteract this problem, there are numerous robots that increase the size of the field of application by using a liquid tank.

Another disadvantage of a wet cleaning unit contoured in this way is that it becomes dirty during the cleaning itself. As a result, the user is usually forced to carry out frequent maintenance tasks on the wet cleaning unit. After cleaning, the textile must be removed and cleaned by hand or in a washing machine. Since this represents a considerable effort, There are also cleaning robots that enable the cleaning of the textiles of the wet cleaning unit in a service station designed as a washing station. There are cleaning robots whose mopping unit is cleaned in the service station/washing station. This measure reduces the effort involved in washing textiles for the user to a large extent. Due to the dampening of the textile during washing in the station, a new sub-area of the cleaning area can be processed after each cleaning process, which increases the size of the area of operation.

This use-case, however, also has its limitations: the robot is forced to drive to the service station as soon as the textile is no longer damp enough. Furthermore, the textile releases moisture immediately after the washing process. In any case, the service station must be placed on a type of floor suitable for wet cleaning. It is also only possible to drive on paths on corresponding floor types. Long distances to the next partial cleaning destination therefore also pose a problem, since the entire path that the robot travels there must be suitable for wet cleaning. Therefore, only paths on floor types suitable for wet cleaning can be used and the washing station must be placed on such a floor in any case. Ultimately, long distances between the station and the target area are unsuitable for such a system, since the textile (the mop) has hardly any moisture left in it after reaching the target area, and the robot has to return to the station soon. This means that the robot needs a relatively long time to cover the distances between the station and the partial cleaning area.

The inventors have set themselves the task of providing an autonomous robot and a service station for the robot, with the help of which processing tasks (e.g. cleaning tasks) can be carried out in a time-efficient manner for large areas, while the necessary user's interaction with the robot and/or the service station is kept as low as possible. In addition, the task is solved of adapting the area of application to the robot in an improved way, in which cleaning is carried out as wet, dry or dry and wet at the same time.

### SUMMARY

This task is achieved by a system or a mobile robot as disclosed in this application. Different examples and developments of the application are subject of the dependent claims.

A system with an autonomous mobile robot and a service station is described. According to one exemplary embodiment, the service station has a cleaning unit, which is designed to clean a cleaning tool or another part of the autonomous mobile robot, and has a waste water connection for disposing of liquid into the public waste water network.

According to a further exemplary embodiment, the service station has the following: a housing with a gate and a parking position arranged inside the housing, which the robot can reach through the gate. The service station is designed to collect particles and/or receive liquids from the robot.

A system with an autonomous mobile robot and a service station is described. According to one embodiment, the system includes an autonomous mobile robot that has a tank for cleaning liquid and a wet cleaning unit for wet cleaning using the cleaning liquid and at least one cleaning tool, and a service station for the robot with a service unit. The robot and the service unit are designed to clean or replace the at least one cleaning tool of the wet cleaning unit. This service station or another service station has a cleaning fluid reservoir and is designed to fill or replace the tank of the robot.

Further exemplary embodiments relate to autonomous mobile cleaning robots. According to one embodiment, the robot has a tank for cleaning liquid and a wet cleaning unit with at least one cleaning tool for wet cleaning of a surface using the cleaning liquid, with the robot being designed to obtain cleaning liquid for cleaning the cleaning tool from the tank of the robot.

According to a further exemplary embodiment, the robot has a wet cleaning unit with at least one cleaning tool for wet cleaning of a floor surface, with the at least one cleaning tool being height-adjustable. The robot is designed to raise and lower the at least one cleaning tool in a washing mode, while the cleaning tool is being flushed with cleaning liquid.

According to another embodiment, the robot has a wet cleaning unit with at least one cleaning tool for wet cleaning of a floor surface, wherein the at least one cleaning tool is height-adjustable, and wherein the robot is designed to, in a drying mode, press the cleaning tool against a surface thereby squeezing liquid out of the cleaning tool and/or removing liquid out of the cleaning tool by moving the cleaning tool, in particular by alternating rotation of the cleaning tool.

According to a further exemplary embodiment, the robot has a wet cleaning unit with at least one cleaning tool for wet cleaning of a floor surface, with at least one cleaning tool being height-adjustable, and with the robot being designed to detect that it is stuck or that it cannot overcome an obstacle. If this is the case, the robot switches to an obstacle mode in order to free itself or to overcome obstacles, for which the at least one cleaning tool is moved, in particular raised and lowered.

According to a further exemplary embodiment, the robot has a wet cleaning unit with one or more cleaning tools for wet cleaning of a floor area and a dry cleaning unit for dry cleaning of the floor area. With regard to a direction of travel of the robot during a cleaning process, the dry cleaning unit is arranged in front of the wet cleaning unit, with the dry cleaning unit and the wet cleaning unit not being arranged overlapping on the robot, so that the dry cleaning unit is not wetted when the wet cleaning unit is cleaning.

According to a further exemplary embodiment, the robot has a wet cleaning unit with one or more rotatable cleaning tools for wet cleaning of a floor area and a dry cleaning unit for dry cleaning of the floor area. With regard to a direction of travel of the robot during a cleaning process, the dry cleaning unit is arranged in front of the wet cleaning unit, with the dry cleaning unit and the wet cleaning unit being arranged such that they are not overlapping on the robot such that during a cleaning process in which a floor surface is cleaned using the wet cleaning unit no cleaning fluid reaches the dry cleaning unit.

According to a further exemplary embodiment, the robot has a wet cleaning unit with one or more rotatable cleaning tools for wet cleaning of a floor surface and a mechanism for raising the wet cleaning unit or the cleaning tools so that the cleaning tools no longer touch the floor. The robot is designed to carry out a drying process by moving the wet cleaning tools in the raised state.

### BRIEF DESCRIPTION OF THE FIGURES

The application is explained in more detail below with reference to the examples shown in the figures. The illustrations are not necessarily to scale, and the application is not limited to only the aspects illustrated. Instead, value is placed on presenting the principles on which the application is based.

FIG. 1 shows a robot with a control device on which software is running in order to carry out work in an area of deployment.

FIG. 2 shows an exemplary block diagram showing various units of an autonomous mobile robot and peripheral devices such as a base station of the robot.

FIG. 3 shows a robot with a service station, in which a robot is supplied with cleaning liquid and the wet cleaning unit is cleaned.

FIG. 4 (diagrams a, b) shows possible cleaning paths that can be achieved with mopping robots with and without a tank.

FIG. 5 (diagrams a, b, c) shows possible cleaning paths with mopping robots with a washing system, with a washing system and a fillable tank and with a non-fillable tank in a field of application.

FIG. 6 shows a wet cleaning unit that can be controlled to deliver cleaning liquid in a targeted manner onto a cleaning tool.

FIG. 7 shows a possible area of deployment with different areas, where area D is not intended for wet cleaning.

FIG. 8, diagram a, shows a cleaning robot with wet and dry cleaning zones; Diagram b shows a cleaning robot performing a wet cleaning process in a service station.

FIG. 9 shows wet cleaning tools in various embodiments

FIG. 10 shows a robot performing a wet cleaning process without a service station

FIG. 11 shows up and down movements of the wet cleaning tool for washing and drying operations.

FIG. 12, diagram a, shows possible movements of the wet cleaning tool for washing and drying processes; Diagram b shows a drying process for a wet cleaning tool with a fan.

FIG. 13 shows ways to use the wet cleaning tool to overcome obstacles and escape from stuck situations.

FIG. 14 shows a wet cleaning zone with a mop that can be rotated and raised or lowered.

FIGS. 15-31 illustrate further aspects of the embodiments described herein.

FIG. 32a illustrates the connections between the robot and station when docked.

FIG. 32b illustrates a container (tank) in the robot with leakage protection in the supply pipe.

FIG. 33a-b shows two examples of a water tank of a robot, the water tank at least partially encasing the duct for dust extraction.

FIG. 34 illustrates different coupling areas (liquid/particles/electrical supply) on the side of the robot.

FIG. 35 shows a service station with a container for waste water (waste water tank) which has a level sensor.

FIG. 36 illustrates the internal arrangement (inside the robot body) of the dust container and water tank, the coupling connections, the suction module (fan) and the drive wheels.

FIG. 37a-b schematically illustrates a wet cleaning by means of a roller and a disc (pad), each of which is lined with textile.

FIG. 37c illustrates the application of liquid to a cleaning pad through a perforated textile support.

FIG. 38a illustrates the cleaning of the robot's cleaning pad on a “washboard” in the service station.

FIG. 38b is a perspective view of a washboard in the service station.

### DETAILED DESCRIPTION

The examples and technical features of the mobile robot described in connection with the processing of a floor area can also be applied to a mobile robot for performing other or additional activities. The activities performed by the mobile robot described can include, for example, the processing of floor surfaces, inspection of the floor surface or the environment, transporting objects, cleaning the air and/or performing amusement games.

A dry cleaning unit is necessary, for example, if only a wet cleaning unit is used, but it may be that the device can also transport objects. The same applies to the service station. A service station can be a device that only performs one function or a combination of different devices. For example, it could only provide a charging function or a water filling function. However, it could also fulfill other or multiple functions. For example, a dust emptying station could be combined with a cleaning station and a water refill function.

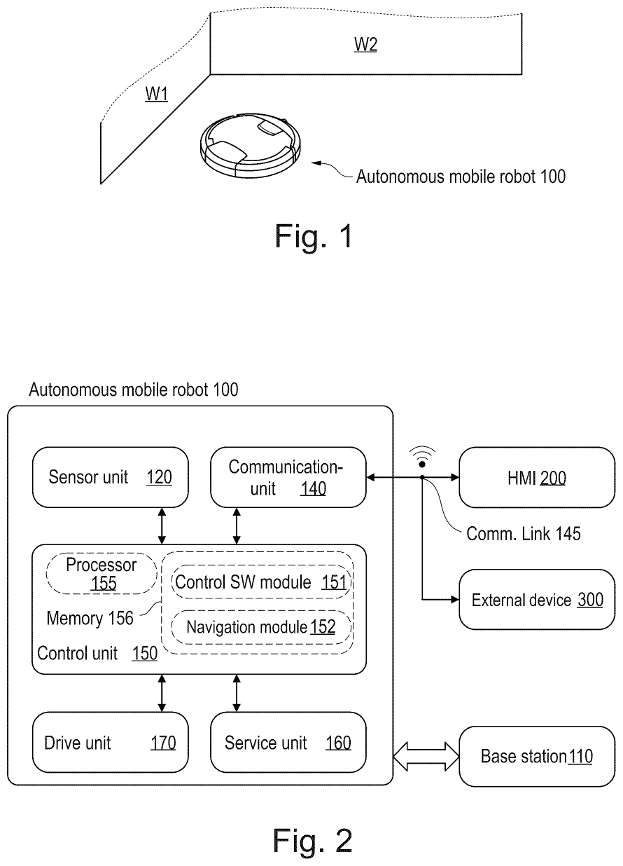

FIG. 1 illustrates an example of a cleaning robot 100. The robot can have different functions: e.g. cleaning robots in different designs or telepresence robots, etc. Modern robots navigate based on a map, i.e. they have an electronic map of the robot's area of operation. In the example shown, the robot is on the move in the operational area and the walls W1 and W2 are its boundaries.

FIG. 2 shows various units (modules) of an AMR 100. A unit or module can be an independent assembly group or part of a software for controlling the robot. A unit can have several subunits. The software responsible for the behavior of the robot 100 can be executed by the control unit 150 of the robot 100. In the illustrated example, the control unit 150 includes a processor 155 configured to execute software instructions contained in a memory 156. Some functions of the control unit 150 can also be carried out, at least in part, with the aid of an external computer. This means that the computing power required by the control unit 150 can be at least partially outsourced to an external computer. This could be accessible, for example, via a home network or via the Internet (cloud).

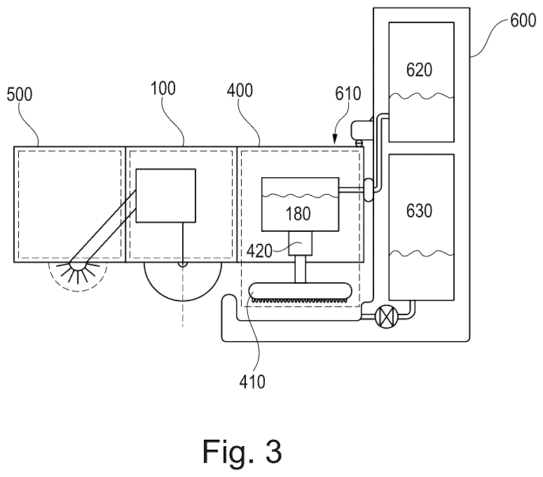

FIG. 3 shows a cleaning robot 100 with a wet cleaning unit 400, which is located in a service station 600. In this case, the service station 600 has a number of devices with which maintenance work can be carried out on a robot. In this way, the robot 100 is supplied with electrical energy 610 and with cleaning liquid. In this case, cleaning liquid is filled from the tank 620 of the service station 600 into the tank 480 of the robot 100. However, it would also be possible for the robot's tank 480 to be exchanged or to be filled up directly via the public water supply network. There is also the possibility that the robot cleans the wet cleaning tool 410 of the wet cleaning unit 400 at the service station 600 or lets it be cleaned. Systems (service station and robot) with this feature are referred to as “washing systems”. In the case of washing systems, it is usual or necessary for the dirty water that accumulates to be disposed of. This is done in the example from FIG. 3 in that the dirty water that collects is pumped into the waste water tank 630, but the dirty water could also be discharged into the public sewage system, for example. A pure washing system does not have a tank for remoistening the wet cleaning unit. The robot has to drive to the washing station regularly to clean and re-moisten the wet cleaning unit.

Systems in which the robot has a cleaning agent tank or can wash (or have it washed) the cleaning tool in the service station aim to increase the size of the possible area of operation of the robot. In the case of a robot with a cleaning agent tank, the range is increased so far until the tank is empty. An unlimited enlargement of the tank is not expedient, however, since attempts are being made to keep the device small and portable and to design it in such a way that it can cover the entire operational area as far as possible. Furthermore, such systems have reached their limit at the latest when the soiling of the wet cleaning unit is so great that adequate cleaning is no longer possible. Robots that allow the mop to be washed also increase the size of the possible area of application. In this variant, excessive soiling of the wet cleaning zone is counteracted because it can be washed but it is necessary to constantly re-moisten the wet cleaning tool. This leads to the disadvantage that frequent returns to the service station are required, resulting in a considerable consumption of time.

Systems in which robots can fill up their tanks at service stations are known per se. The disadvantage of these systems, however, is that their wet cleaning zone (wet cleaning unit) also gets dirty, which means that only a limited increase in range is possible.

In the exemplary embodiments described here, the features of cleaning the wet zone (wet cleaning unit) and a tank located in the robot, which can be refilled at a station, are combined in such a way that the user has significant advantages during operation. All combined features are primarily aimed at increasing the range and -taken individually-come up against limits. In the case of robots according to the exemplary embodiments described here, the combination of features naturally also results in an increase in the field of application. However, this combination clearly surpasses known systems and at the same time saves time compared to known approaches.

Washing systems are a good choice for wet cleaning robots because they can be operated until the tank at the service station can no longer provide cleaning liquid for the robot. Assuming that the washing-only system at a service station has the same amount of cleaning liquid available as the invented system, it can be stated that the washing-only system also enables a similarly large workable area. However, with the restriction of the range of the washing-only device due to the driving to and from the station.

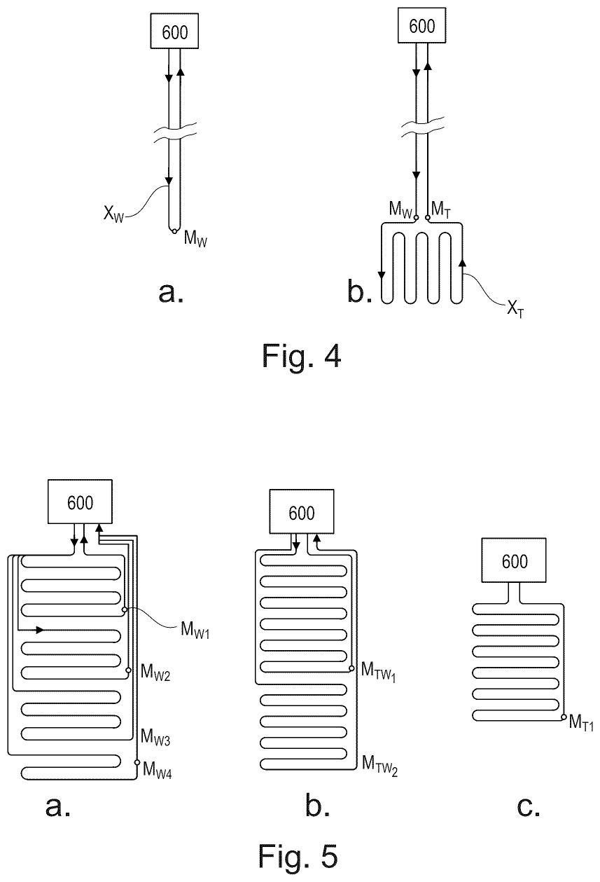

The washing-only device (without a tank) can never cover a distance that is greater than its wet cleaning tool allows for, since only this is moistened and releases moisture to the floor immediately after leaving the service station. In the exemplary embodiments described here, the wet cleaning tool 400 of the robot 100 can be regularly remoistened by means of the tank 480 of the robot and thus also enables distances that go beyond the maximum of a washing-only system. FIGS. 4a and 4b show a comparison of the two systems. In FIG. 4a, the path of the robots is compared using a bird's eye view. The trajectory Xw of a washing-only system shows the path that leads from the service station 600 to the point Mw of the path that is furthest away from the service station. FIG. 4b shows the trajectory XT of a washing system with a tank, which leads from the service station 600 beyond the waypoint Mw to the point MT. It can be seen that a robot with a tank (and similar conditions) can also work on areas that lie beyond the waypoint Mw.

If the distance between the point Mw and the service station is large enough to reach every point in the area of operation, a complete cleaning of the area can be conducted. In this case, however, the exemplary embodiments described here offer the advantage of a significant reduction in cleaning time, since repeated trips to the service station are only rarely necessary. A return to the station only takes place when water has to be refilled or the wet cleaning unit needs to be cleaned and no longer when the wet cleaning tool is too dry.

FIG. 5a shows processing of an area with a washing system at waypoints Mwi, MW2, MW3 and Mw4. It is necessary to return to the service station 600 at each of these waypoints, since the wet cleaning tool is no longer wet enough. The driving time required increases the total cleaning time and causes disproportionately poor cleaning times when driving to remote points, since the serviceable area at the edge of the operational area is becoming smaller and smaller. For the robot from FIG. 5b with a refill tank and washing system (tank 480 in the wet cleaning unit 400, cf. FIG. 3), there is a gain in processing time compared to the situation in FIG. 5a. This is a clear advantage for service robots, since more time is available to perform other tasks or to be generally available to the user. However, even in this case, the robot must return to the service station at the waypoints MTWI and MTW2 in order to wash the cleaning tool (e.g. mop) in the service station or have it washed. FIG. 5c additionally shows the movement of a robot in a case in which the robot has a tank, but the service station is not designed for washing the cleaning tool or for refilling the tank of the robot. It is immediately apparent that with such a system it is not possible to completely service the entire surface without the user's help, since the tank can no longer be filled up or the wet cleaning tool will eventually become too dirty to carry out further cleaning.

For the user, the refill tank and washing system has the advantage that the entire desired area can be cleaned and that this can also be done comparatively quickly, as well as the advantage that the robot has to drive to the service station less often. This is particularly advantageous when the user is in the vicinity of the service station and could be disturbed or distracted by the robot. Furthermore, the floor in the area of the service station is driven on less frequently. This leads to less wear and tear of this floor-area as well as reduced wearing of the components of the robot. Of course, this advantage applies in particular when the wet cleaning unit is in processing mode and the floor is only partially suitable for wet cleaning, such as hardwood flooring. It is of particular advantage if the size of the tank is matched to the typical soiling of the wet cleaning unit. This makes it possible to determine the best possible time for the robot to return, to both fill up the tank as well as to effectively clean the wet cleaning tool, whereby the robot can have a relatively small size.

Compared to systems without a washing function, the user also has the advantage of fewer necessary user interactions. The user interaction in systems with a washing function is primarily limited to filling and emptying the liquids in the station. Maintenance of the robot or the wet cleaning tool is no longer respectively only occasionally necessary.

Especially in the case of home cleaning robots, which are also intended for use in private surroundings, users are expecting more and more freedom from maintenance. For dry cleaning devices, this is easily solved, for example, by vacuum-emptying the dust container in the robot. With wet cleaning devices, however, it is still problematic that all devices on the market require regular complex maintenance. This effort is often considerable, especially with wet cleaning devices without a washing system, since the textiles of the cleaning tools have to be cleaned by hand or in the washing machine. The exemplary embodiments described here make it possible for the robot (without the need for user interaction) to quickly clean large areas even when the user is not present.

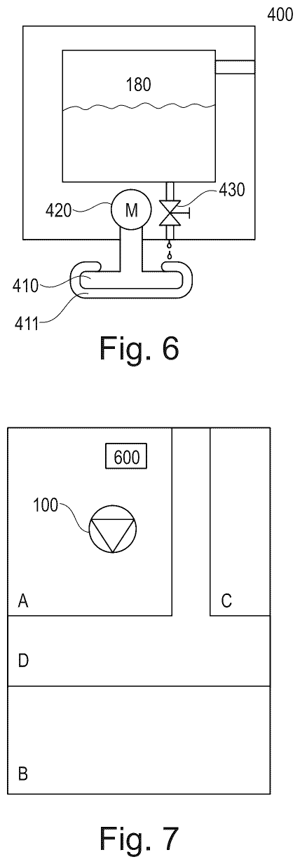

If the wet cleaning unit 400, as shown in FIG. 6, is constructed in such a way that it can also be adjusted whether cleaning liquid is introduced from the tank into the wet cleaning tool, the size of the possible operation area increases significantly again. This is implemented, for example, by means of a controllable valve 430 or a pump that controls the delivery of the cleaning liquid from the tank to the cleaning tool 410 (and thus to the textile contained therein). In this case, the only limitation is the size of the liquid containers in the service station. This is due to the fact that previous systems had firm usage limitations. In any case, tank systems (liquid tank only in the robot) are limited by the degree of contamination of the wet cleaning unit. Pure washing systems (without a tank in the robot, the cleaning tool is washed/moistened in the service station) are limited by the fact that water is constantly released on the way from the service station to the actual area of application. This happens on the one hand by wetting or dripping off of the moisture from the cleaning tool and by evaporation. It is therefore the case that when you reach a distant destination, there is significantly less cleaning liquid in the wet cleaning tool than when you leave the service station. This circumstance reduces the area in which adequate wet cleaning can be carried out. By using a sealable tank (in the robot) this limitation is removed. The distance to the area of application is now only limited by physical limitations and the power supply of the robot. With this measure, the cleaning liquid could be dispensed only if needed after a certain point. Thus as an example, as shown in the example of FIG. 4b, the robot can be controlled in such a way that water/cleaning agent is only released from the tank from the waypoint Mw onward. Another advantage that results from this is that resources are conserved with regard to the cleaning liquid, since this no longer evaporates on the way to the waypoint Mw or is released onto the ground.

This system is also advantageous if an area of operation is to be reached that is cut off from the base station by areas that are not suitable for wet cleaning tools. For example, it can happen that the tiles in the bathroom need to be cleaned, but the path to the bathroom leads through rooms that have carpeted floors. In the case of a controllable tank, nothing stands in the way of crossing the carpeted area when driving to the bathroom, provided the wet cleaning tool is not damp. As soon as the robot is in the bathroom, it can apply the cleaning liquid to the wet cleaning tool and start cleaning. FIG. 7 illustrates this relationship. A bird's-eye view of a deployment area is shown, which is divided into areas A, B, C and D. The robot and the service station are located in area A. Areas A, B and C are suitable for wet cleaning, but are separated from one another by area D, which is not suitable for wet cleaning. A cleaning of B would be possible after filling the tank in the robot 100 at the service station 600 under the assumption that the wet cleaning tool is still dry.

However, it is still not readily possible for the robot 100 to return to the service station 600, which is located in area A, since the residual moisture in the wet cleaning tool could damage the carpet D. To counteract this, it is possible, for example, for the robot to start a drying process, which will be discussed in more detail later.

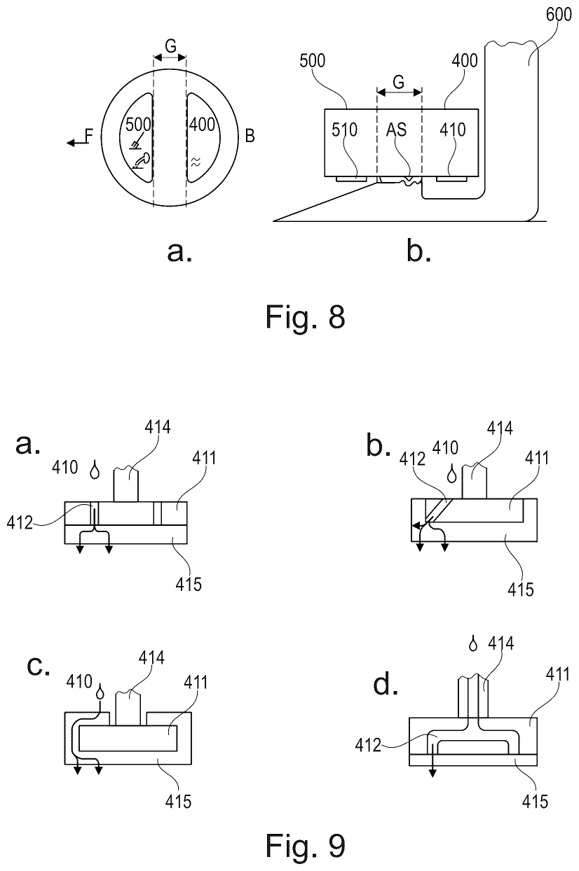

A further improvement of the robot could be achieved by additionally equipping it with a dry cleaning unit 500. The dry cleaning unit 500 is usually realized by a sweeping function, a suction function, or a combined sweeping and suction function. There are already some products that combine a sweeping and suction function with a wet cleaning function. However, these are not equipped with a washing function or tank filling function in the robot. In the example shown in FIG. 8 a, a robot is shown in a top view, which has a dry cleaning unit 500 and a wet cleaning unit 400. It has a front side F and a rear side B. The dry cleaning unit 500 is separated from the wet cleaning unit 400 by an area such that the units 400 and 500 have a distance G. The main advantage of combining a dry cleaning unit and a wet cleaning unit is that loose and easily detachable larger particles can first be removed from the floor and then stubborn dirt can be removed with the help of the wet cleaning unit. In order to accomplish this, many cleaning robots are constructed in such a way that with a forward movement the dry cleaning unit/area precedes the wet cleaning unit/area. Since robots usually drive forwards, the docking movement to the service station is usually designed in such a way that the robot docks with the dry cleaning unit first.

When washing the wet cleaning unit (in the service station), this however leads to a problem, since the dry cleaning unit located at the front travels over an area that is intended for cleaning the wet cleaning unit. This can lead to undesired moisture entering the dry cleaning unit. In order to prevent this, according to one exemplary embodiment, the robot can dock in such a way that it first drives into the service station with the wet cleaning tool, in which the washing of the wet cleaning unit is carried out. This could be done, for example, by the robot driving backwards into the service station. While this makes the docking process a bit more complicated, it allows for better protection of the dry cleaning unit. FIG. 8b shows the side view of a robot in a washing station (service station designed to wash the robot's wet cleaning unit), in which this principle has been implemented. The wet cleaning unit 400 with the wet cleaning tool 410 lying underneath is moved into the service station 600 in such a way that the dry cleaning unit 500 and the dry cleaning tool 510 are not affected by the moisture. This happens primarily due to the distance G or due to splash protection structures AS in the area G of the robot 100 and the service station 600.

In particular, the protection of the dry cleaning unit is given when the dry cleaning unit and the wet cleaning unit are not constructed in an overlapping manner as in FIG. 8. Thus, according to some embodiments, the zones can be separated by the distance G, in that the robot housing forms a continuous area between the units 400 and 500, for example. If the distance is sufficiently large, contamination of the dry cleaning unit is almost impossible. In addition, for example, a bulge AS (splash protection structure) in the robot housing can also offer such protection. Furthermore, it is conceivable that similar splash protection structures can also be attached to the service station.

This spatial separation of the units 400 and 500 and the splash guard are of particular interest when the wet cleaning unit is washed in the service station. During the cleaning of the wet cleaning tools, it can happen that splashes of cleaning liquid occur in (or around) the washing area in the vicinity of the wet cleaning tool 410. According to the exemplary embodiments described here, these should be prevented in such a way that they do not influence the dry cleaning unit 500. Air currents can also be used to provide additional protection for the dry cleaning unit. It is thus possible to direct an air flow from the dry cleaning area to the wet cleaning area, which causes splashes not to fly towards the dry cleaning unit. This could be realized by a blower but also by suction. It is possible that a corresponding air flow generating device is implemented in the robot or in the service station. The use of such an air flow generating device offers the additional advantage that the robot and service station are better ventilated and thus it is more difficult for bacteria or fungi to form due to the circulating air. Furthermore, it is possible to dry the damp areas of the wet cleaning tool. Further advantages of drying the wet cleaning tool will be discussed in detail later.

The wet cleaning unit can be washed by rinsing and scrubbing the wet cleaning tool in a recess of the base station, with the cleaning liquid being provided directly from the base station. According to one exemplary embodiment, both a part of the cleaning liquid contained in a tank of the service station and a part of the cleaning liquid contained in a tank of the robot can be used for cleaning the wet cleaning tool. This offers the advantage that dirt contained in the wet cleaning tool is flushed with liquid coming from inside the robot. In the example shown in FIG. 6, this basic principle is already recognizable. With the valve 430 (or alternatively with a pump), cleaning liquid is applied to the cleaning tool from the inside. In the simplest case, when washing the cleaning tool, the same mechanism could be used that is also used to moisten the cleaning tool when cleaning the floor. More complex systems could also use other devices that provide for example a special cleaning liquid for the washing process.

The cleaning fluid used by the robot for floor cleaning or washing can be applied (from the inside) to the back of the cleaning tool, for example. Here the back side refers to the side that doesn't face the ground. Some possible variants for such an application of liquid to the wet cleaning tool 410 are shown in FIG. 9. The cleaning tool can consist of several parts. In these cases, there is always a connecting piece 414 to the robot, a wet cleaning base plate 411 and a wet cleaning textile 415. The liquid is applied by the wet cleaning unit 400 and soaks or rinses the cleaning tool with the help of capillary forces and gravitation. Contamination is also flushed out of the cleaning tool 410 in the process. Channels through the wet cleaning base plate 411 are denoted by 412. These channels 412 are used to conduct the liquid to the textile 415

If, when cleaning the wet cleaning tool, the pump or the valve are used, which are intended for emptying the tank, costs can also be saved. Furthermore, the reduction in mechanically moving parts leads to a lower error rate in the overall system.

Some systems have the ability to move the wet cleaning tool horizontally. This is used to increase the cleaning efficiency when wet cleaning floors. When cleaning the wet cleaning tool, this cleaning effect can also be increased during washing by rubbing the cleaning tool on certain areas in the station. It is advantageous that the same drives can be used to move the wet cleaning tool when washing and when cleaning the floor.

The washing, meaning the cleaning process of the cleaning tool, is carried out by rinsing and rubbing movements. This usually requires larger amounts of cleaning liquid, e.g. water, than is the case with normal floor cleaning. This additionally required cleaning liquid could originate from the robot's tank on the one hand, or be provided directly from the service station by additional water on the other hand. Furthermore, it is conceivable that this flushing water is applied to or into the cleaning tool at increased pressure. In this case, for example, the valve shown in FIG. 6 could be replaced by a pump and thus also allow flushing at a higher pressure.

According to one embodiment, the robot itself can control the rinsing of the cleaning tool and can also carry out supporting washing movements by moving the cleaning tool, resulting in the possibility that the robot can autonomously control which kind of cleaning is to be carried out. This can bring several benefits. For example, different washing programs could be carried out that are beneficial due to the circumstances of the robot's area of application. This can be done, for example, by evaluating the map of the operational area used by the robot. Another option would be to evaluate the floor or objects present or detected in the operational area.

The service station can also be designed to be structurally simple and robust and, according to one exemplary embodiment, could only provide basic interfaces, such as for example topping up the cleaning liquid or disposing of the waste water liquid. It is thus possible to build a service station that does not require any data communication with the robot and still offers the possibility of providing functions adapted to the environment.

According to one embodiment, when cleaning the cleaning tool, the cleaning liquid that comes from the tank in the robot is usually applied to the cleaning tool at the top, side or from inside the wet cleaning unit. FIG. 9 shows different variants of how cleaning fluid can be applied. When applying the fluid from above, on the one hand gravity can be used, on the other hand flushing with increased pressure could also take place. Movement of the wet cleaning unit or the wet cleaning tool can be advantageous to the application and distribution of the cleaning liquid. For example, when using rotating cleaning tools when the liquid is applied to one point, the liquid can be distributed over the entire circumference of the cleaning tool by means of rotation (i.e. by means of centrifugal force). In addition, better application or rinsing can be made possible by cavities and channels 412 being located in or on the cleaning tool or by the cleaning plate 411 being constructed in the form of a grid. As a result, the cleaning fluid can be better distributed or can be directed to the relevant areas of the cleaning zones more quickly. Textiles can also be used, the capillary forces of which ensure the distribution of the liquid, or rotating cleaning tools can be used, in which centrifugal forces ensure better rinsing of the cleaning tool. Another advantage that has already been briefly mentioned and that results from using the cleaning liquid from the tank is that the same valve or pump can be used which is also used for applying the liquid for floor cleaning. It should be noted that a higher water consumption per unit of time is usually necessary for a cleaning process of the wet cleaning tool than is the case for floor cleaning.

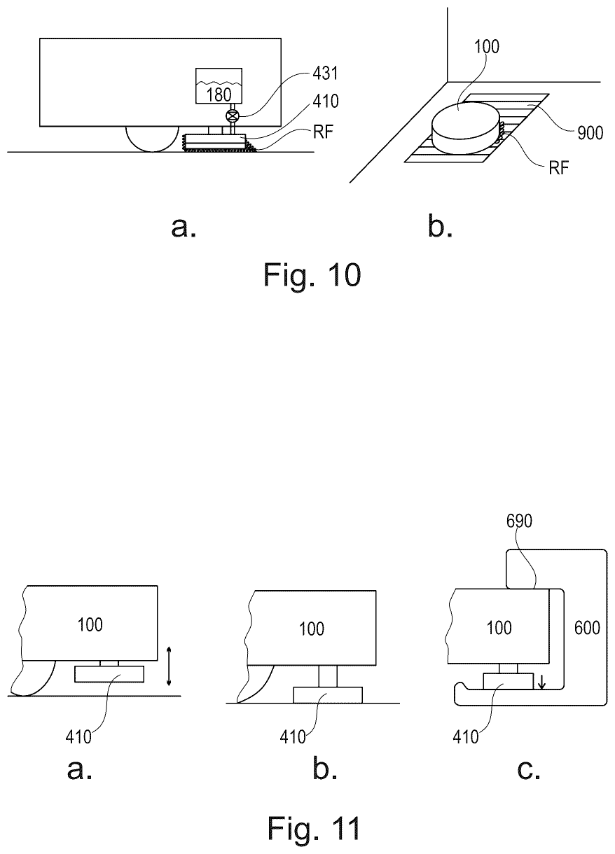

According to one exemplary embodiment, it is also possible for the robot to wash itself completely independently. It would not even be necessary to have a service station, which is usually required for the cleaning process of the wet cleaning tool. FIG. 10a shows a robot during such a washing process. For washing, liquid is removed from the tank 180 and applied to the cleaning tool via a pump 431. However, since the cleaning fluid RF is dispensed during the cleaning process of the wet cleaning unit, care must be taken to ensure that this does not cause any damage. Depending on the area of application, this may or may not be the case. If this is the case, the user could also just buy the robot. If this is not the case, a system consisting of a robot and a service station with a washing unit could be made available for him. One possibility for use without a washing station would be, for example, if the robot 100 carries out the cleaning in a drainage area 900 of the operational area. FIG. 10b shows an example of this.

Such a drainage area 900 could be, for example, a drainage area 900 contained in the floor of a bath. It is sometimes common for bathrooms to have a slight incline in the floor and for the lowest point to have a drain through which the water can flow into the public sewage system. Drainage areas 900 of this type are often also covered with a perforated cover, for example a grid. This cover can in one exemplary embodiment also be used as a washboard for the cleaning process. The robot could thus clean itself without the service unit of a service station. It would also be possible for the robot to have an additional unit or function that removes contamination caused by the dispensed cleaning liquid RF from such a washing process.

In order to make the cleaning process more efficient in addition to rinsing with cleaning liquid, it is possible to use a movement of the wet cleaning tool. Some previous systems already use movements of the wet cleaning unit to support the cleaning process. For example, by rotating the cleaning tool over a scraper, a washing movement can be generated. This roughly corresponds to the principle of hand washing clothes. The cleaning tool with cleaning agent and liquid is repeatedly drawn over a curved surface. The main disadvantage of this type of cleaning is that the cleaning tool is always processed with the same pressure on the cleaning tool. This pressure is primarily due to the weight of the robot.

In order to make the cleaning process even more efficient, according to one embodiment, the wet cleaning tool or, of course, alternatively the entire wet cleaning unit, is to be raised or lowered. FIGS. 11a and 11b illustrate such a concept. Here, the wet cleaning tool in FIG. 11a was in the raised state and 11b shown in the lowered state. By lifting and lowering, which can of course also be repeated arbitrarily often, as well as by other, e.g. horizontal or rotating, movements of the cleaning tool and the adjustment of the amount of cleaning liquid, the washing process becomes even more efficient. In contrast to other systems that rely on the pure weight of the robot for washing, a height-adjustable wet cleaning tool can also generate pressure that exceeds the pure weight. This is made possible, for example, by using the inertial force of the robot. In order to achieve a relevant result here, a correspondingly high acceleration of the wet cleaning tool is of course necessary.

Another possibility for generating high pressures is shown in FIG. 11c. The robot together with the wet cleaning tool is brought into an area (e.g. in the service station 600) that has a certain height. By subsequently extending the cleaning tool to a distance that corresponds to this height, the robot can push itself off its top side and generate a relatively high contact pressure, as a result of which the moisture is pressed out of the textile of the wet cleaning tool 410. The service station 600 shown in FIG. 11c, for example, offers possibilities for such a process. Corresponding supports 690 could be provided in it, on which the robot can push itself off.

The variants presented also offer the possibility of specifically varying the contact pressure during cleaning processes of the wet cleaning unit. This can be used, for example, to provide different washing programs. Other options can of course also be used to create washing programs. The amount of cleaning liquid used for rinsing can be varied or additional cleaning liquid can be used. It would be conceivable that a normal thorough cleaning only involves rinsing with water and that intensive cleaning also uses detergent. In both cases, the means provided for this could be obtained from the robot or from a service station.

A further advantage of this squeezing of the textile is that it creates the possibility of reducing the moisture in the cleaning tool. This can be used, for example, to bring the humidity to suitable (low) values for processing certain areas. This is not possible with previous systems, since the same forces are always used there and the same amount of moisture is therefore present after the washing process. In addition, these systems have the disadvantage that they initially have very damp cleaning tools, which then become drier and thus cause uneven cleaning. In the exemplary embodiments described here, it is possible for the robot to set the humidity within wide limits. This happens the first time wetting or at the end of the washing process, i.e. during or after cleaning the wet cleaning tool. If the robot has the control elements (pumps, valves, etc.) for this, the robot can also control the liquid delivery to the wet cleaning tool while it is working the floor. In this way, cleaning can take place which ensures that the wet cleaning tool is continuously evenly moistened. The moisture condition could additionally be detected by a moisture sensor. This offers the advantage that an adequate setting of the desired humidity is possible even more precisely. This is the case, for example, in an application area with different floor types. Above all, living spaces often consist of rooms with a wide variety of floor types. A tiled bathroom, entrance areas with parquet flooring and living room areas with carpets are quite common. These areas often also have different requirements with regard to their care with damp cleaning agents.

In addition to adjusting the humidity by squeezing out the cleaning tool, in some exemplary embodiments there is the possibility of raising the wet cleaning tool 410 (cf. FIG. 11, diagram a, raised state of the wet cleaning tool). By raising and closing the water supply to the wet cleaning tool, the robot can be put into a mode in which the wet cleaning tool dries (drying mode).

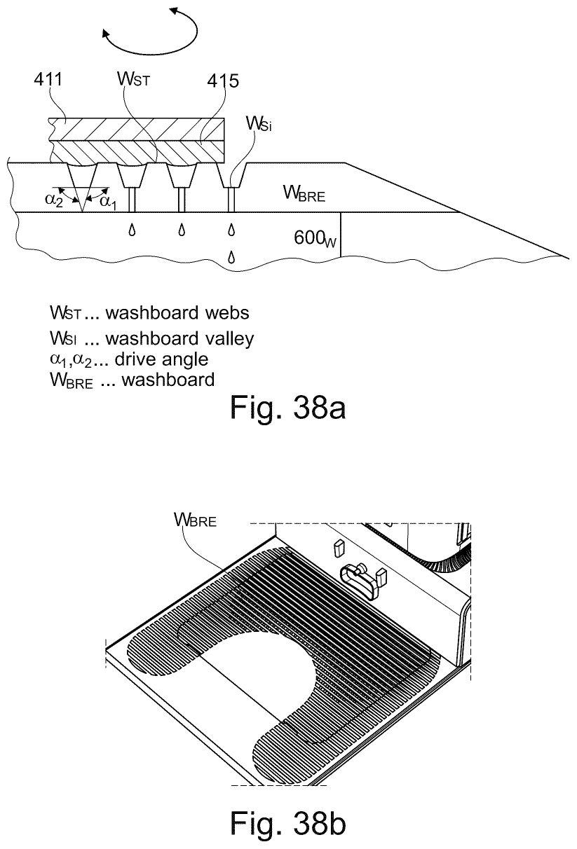

Drying of the wet cleaning tool 410 can take place either directly on site or at the station. Movements of the wet cleaning tool 410 as well as blowers or heaters can be used to enable faster drying. Both could be made available both directly on the robot and at the service station 600. For additional disinfection, the textile of the wet cleaning tool or the cleaning liquid could be irradiated with UV light. As already mentioned, a washboard (see also FIG. 38b, washboard WBRE) can be used in the service station when drying a wet damp cleaning unit.

The washboard can, for example, be shaped in such a way that the robot stands on the washboard and this has beads or openings at the edges of which the cleaning liquid and dirt can be rubbed off or squeezed out (see also FIG. 38a, webs WST, valleys Wsi). Additional squeezing pressure could be applied by extending the wet cleaning tool. There is also the possibility that the edges of the beads or openings have different angles α1, α2 (see FIG. 38a), so that a movement of the wet cleaning tool (see FIG. 38a, textile carrier 411, textile 415 form the cleaning tool 410) leads to the same spot of the wet cleaning tool being scraped off or squeezed out with changing abrasion angles.

In the case of rotating wet cleaning units, the axis of which is normal to the washboard, the same angles α1, α2, due to the rotation of the tool, also automatically lead to changing abrasion angles if they are not parallel to the axis of rotation or the beads are not arranged radially around the pivot point of the wet cleaning tool. A change in the direction of rotation can also be used with rotating wet cleaning tools to change the abrasion angle and increase the cleaning effect or improve the drying process. Some ways to vary the angles between webs and beads are shown in FIG. 38. As an alternative or in addition, bristles or other structures could be introduced into the grooves, which allow access to the wet cleaning tool and further improve the cleaning or drying process. All of this can contribute to a better cleaning effect and a faster drying process.

When drying a heavily soaked wet cleaning unit, the moisture should preferably be squeezed out at the service station as soon as possible, since a lot of liquid can be removed from the wet processing unit in a short time through squeezing. Although a drying with a blower or heater achieves a good final drying result, it also requires significantly more time depending on the design. Combining both methods with initial squeezing and subsequent drying by means of heating and/or ventilation, is therefore recommended.

If the wet cleaning tool is dry it could then also be used as a dry cleaning tool. It would then be possible to polish surfaces by lowering the dried wet cleaning tool to the floor. Areas could be processed with or without additional movement of the dried wet cleaning tool. To make drying even faster, in drying mode, the robot can move the tool while being in the raised state.

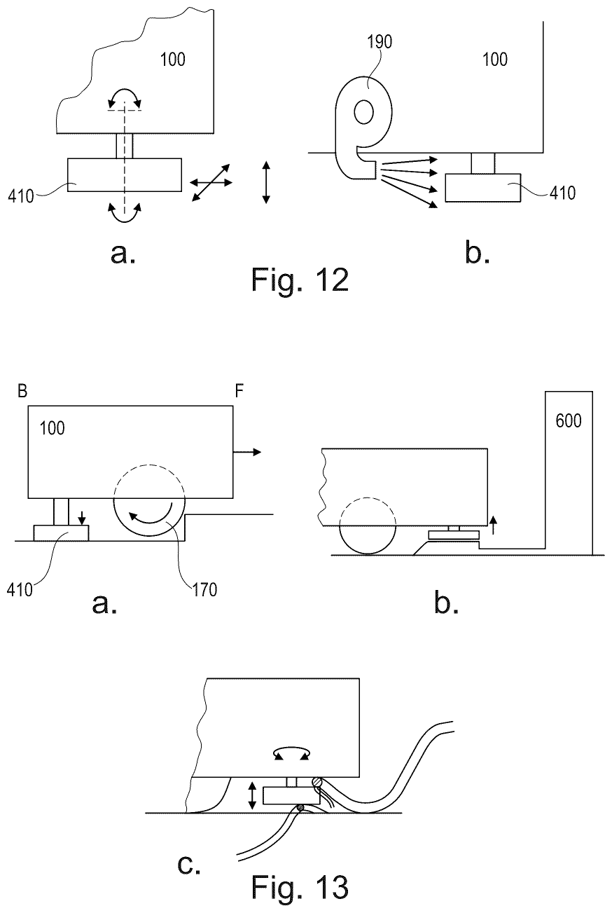

FIG. 12a shows possible movements a wet cleaning tool can perform to dry faster. The same movements can of course also be used when moistening or washing. Depending on the design, the wet cleaning tool can be moved, for example, by shaking or rotating or by changing direction. Another way to achieve faster drying is to place the wet cleaning tool in an area of dry airflow. This aspect is illustrated in FIG. 12b. This air flow could also have a higher temperature than the surrounding area and of course also be combined with the movement of the wet cleaning tool. As already explained above, the air flow can take place, for example, by means of a blower 190 in the robot or in the service station. Further possibilities when using an air flow of the robot will be discussed again later.

As already known from patent U.S. Pat. No. 7,578,020B2, raising a wet cleaning unit can be used to avoid, for example, carpet floors coming into contact with the wet cleaning tool. However, complete safety cannot be guaranteed, as it cannot be guaranteed that the wet cleaning tool is actually so dry that no liquid is guaranteed to drip onto the floor. In the mentioned publication it is only pointed out that lifting the tool for carpets is a possibility. For better protection of carpeted areas, the moisture sensor discussed briefly earlier could be used to ensure that it is safe to drive over moisture sensitive areas. FIG. 7 shows an example of an area of application in which the drying function makes it possible to process all wet areas A, B and C, since the carpeted area D can be safely driven over without the risk of the carpet getting damp. Dry cleaning of area D after the wet cleaning tool has dried is also possible. Alternatively, the wet cleaning tool could only be raised provided the humidity does not exceed a level at which area D would be at risk.

In addition to the possibility of using the height-adjustable wet cleaning tool for washing and drying, it can also be used in an obstacle-surmounting mode of the robot. For example, if the robot gets stuck in a certain environment and can no longer free itself with the means at its disposal, or if the robot is caught at an insurmountable step, it is possible that the robot can use movements of the wet cleaning tool to free itself, or overcome the hurdle (step). This can be done, for example, by using the wet cleaning tool to support/push itself off or by lifting/lowering caught objects or by releasing them by turning. FIG. 13 shows some possibilities of such liberation and overcoming modes. For example, FIG. 13a shows the overcoming of a step by means of friction force support of the wet cleaning unit. This means that by pressing the wet cleaning unit, the friction is increased and the robot is prevented from slipping back and its wheels from spinning. 13b illustrates the lifting of the wet cleaning tool when docking at the service station. FIG. 13c illustrates moving the wet cleaning unit to free itself from cables.

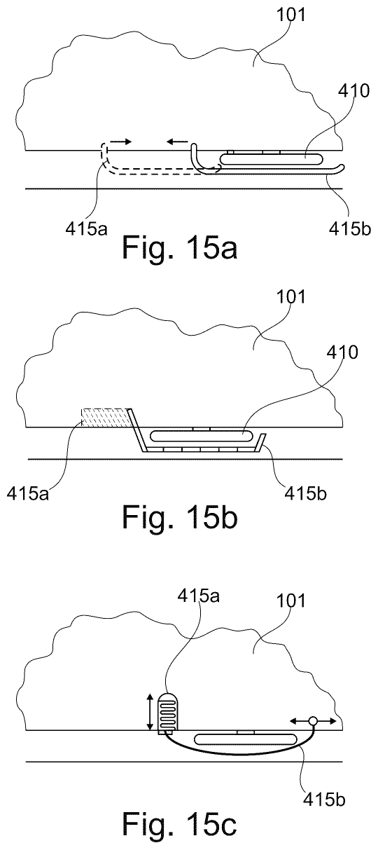

As already mentioned above, it is advantageous for robots that have both a dry cleaning unit and a wet cleaning unit if no moisture can get into the dry cleaning unit in the course of cleaning the wet cleaning unit. This has already been explained with reference to FIG. 8. In the exemplary embodiment illustrated in FIG. 15 this is achieved in that the robot has separate zones for the dry cleaning tool 510 and the wet cleaning tool 410. These zones are separated from one another in such a way that liquid splashes from the wet cleaning zone into the dry cleaning zone are prevented or at least reduced. This can be done on the one hand by larger distances, or on the other hand, by bulges on the housing or components applied to the housing in a sealing fashion, which represent such a bulge. Furthermore, the previously mentioned use of an air flow is also possible. The bulges AS on the robot 100 are of particular advantage when the robot is cleaning the wet cleaning unit away from the service station, since the latter then cannot guarantee protection.

Furthermore, it is understandable that such protection by the bulge AS of the dry cleaning unit is also expedient when the robot is in floor cleaning mode. There are currently devices available on the market that have separate dry cleaning zones and wet cleaning zones. However, these usually have no possibility of moving the wet cleaning tool or only a possibility of vibrating movement to work on the floor. Wet cleaning proves to be particularly advantageous when rotating wet cleaning tools are used. Due to the large surfaces of wet cleaning tools and the limited space in the robot, it is not easy to separate the wet and dry cleaning zones in this case. According to some embodiments, this is achieved in that the wet cleaning unit and the dry cleaning unit are separated by the housing. Similar to the cleaning process of the wet cleaning tool, the protection of the dry cleaning zone can be achieved by taking the same precautions. This can be done through increasing the distance G between the dry cleaning zone and the wet cleaning zone, or by a continuous part of the robot housing clearly separating these zones. Separating the wet and dry zones by dividing them into different assemblies, baffle plates or other bulges would be other possible design variants, as mentioned above.

Of course, air currents could also be used again to protect the dry cleaning unit from the transfer of moisture from the wet cleaning unit. Many dry cleaning devices have an air pump. This is used to pick up dust and collect it in a container on the robot. The exhaust air from this unit could be used for such protective functions, for example.

Of course, the same air supply could then also be used in the drying process. If the air is also routed through warm areas of the robot, the drying performance can be increased on the one hand and components can be cooled by the air on the other.

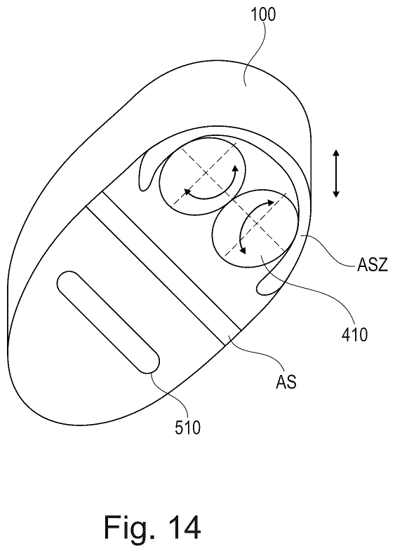

Some embodiments are particularly advantageous because the wet cleaning tool described can rotate as in FIG. 14a and can also be raised. In the example shown in FIG. 14a, the underside of a robot 100 is shown, which has a dry cleaning tool 510 and a wet cleaning tool 410 at its disposal. The splash guard AS is also depicted and separates the two cleaning areas. The wet cleaning tools rotate in opposite directions and can be reversed. Furthermore, they can be raised. In addition to the advantages already described, drying of the wet cleaning tool by lifting and rotating is particularly efficient in this case, since the resulting high speeds at the edge of the cleaning tool enable the liquid to be ejected or evaporated quickly.

The drying function of the wet cleaning unit is possible at a service station, in particular at a service station that is specially equipped for cleaning the wet cleaning unit. Furthermore, it is of course also possible to carry out the drying in the entire area of application. Care must be taken to ensure that the ejected liquid or moisture does not cause any damage. On the one hand, this can be done by the robot only carrying this out at suitable locations or by only carrying out the drying in compliance with certain limit values at which it can be expected that, for example, no liquid splashes will occur. For example, the rotation speed of the wet cleaning tool could have such a limit value. Another possibility arises from the fact that the robot itself has protective plates and/or channels ASZ, with which the ejected liquid or moisture is caught.

Another advantage of the design of the robot with a rotating wet cleaning tool is that it is relatively easy to use the same motor for horizontal movement for several wet cleaning tools. It is also possible for the robot to use the same drive for lifting the tool or, alternatively, for the entire wet cleaning unit, as for rotating the tools. For example, rotating the motor in one direction could push the tool down and rotating the motor the other direction could lift the tool.

Another way to dry the wet cleaning tool 410 is to use a heater. This could be operated electrically, for example. For example, heating coils in the vicinity of the wet cleaning tool or even in the wet cleaning tool itself could result in heating that enables even faster drying. Appropriate electrical insulation could be provided so that the moisture in the wet cleaning tool does not cause any short circuits. The energy could also be transmitted wirelessly or through isolation transformers, e.g. by electrical induction.

All presented variants of the drying of the wet cleaning tool require energy and, above all, time. A much faster and also more energy-saving method to protect certain floor areas from a damp wet cleaning tool is to cover the wet cleaning tool. According to one exemplary embodiment, this can be implemented in such a way that a cover 415 is pushed or pulled over the wet cleaning tool 410. It is also possible to store the wet cleaning tool inside the robot.

In embodiments in which the robot can lift the wet cleaning tool (lifting function), the covering of the wet cleaning tool can be combined with the lifting function. Thus, the cover could be pushed or pulled over the wet cleaning tool during or after the lifting of the wet cleaning tool 140. Depending on the design, this could be implemented with several or with just one drive unit. For example, with rotatable wet cleaning tools, it would be possible that rotating the motor in the opposite direction to the normal direction of rotation (used during cleaning) would result in the cover being moved over the wet cleaning tool. It is also possible that certain speeds of rotation of the engine will result in the covering.

When realizing the cover, it is of particular advantage in some exemplary embodiments if the cover or the parts of the cover are designed in such a way that any moisture (e.g. drops) remains in the cover and thus the moisture does not reach the floor. On the one hand, this could be made possible by collection areas within the cover, but also collection areas within the Robot or its housing are possible. Since such collection areas have capacity limits, it must be ensured that these are not exceeded. Ways to do this would be by draining the liquid in an area that needs wet cleaning anyway, disposing of the moisture at a service station, evaporating the liquid, or reusing it for cleaning. Furthermore, it makes sense according to some embodiments to carry out a detection as to whether such a capacity limit will soon be reached. Sensors can be used here, as well as model calculations that allow the fill level of the collection areas to be estimated based on time, moisture content of the wet cleaning tool and other influencing factors.

In FIG. 15a-c different variants of the cover of the wet cleaning tool are shown. Reference numeral 415a designates the uncovered position of the cover, 415b the covered position. This can be a type of cavity (see FIGS. 15a-b) that can be pushed or pivoted over the wet cleaning tool 410 by means of rails, rotary devices or similar mechanisms. A movement by cable pulls is also possible. The kinetic energy can be generated with the help of motors or springs. In the case of springs as energy storages, it makes sense to charge or preload them using other drives (e.g. brush motors). As a result, additional motors can be saved.

A covering by means of a film is also possible (cf. FIG. 15c). The main advantage of this is that it is light and can be stowed away to save space. The movement to cover the wet cleaning tool 410 can take place in a form similar to that already described above. It is also possible to use a cushioning film, which can take on a number of different forms. In this case, by changing the volume of the cushioning film or the gas pressure in the cushioning film, the various desired shapes of the cushioning film can be produced. For example, the padding film can be fully unfolded to form the cover and fully folded to realize the stowed state.

Regardless of whether the cover for a wet cleaning tool is present, a robot with a dry cleaning device and a wet cleaning device offers the possibility of carrying out both dry and wet cleaning. The robot can decide whether dry or wet cleaning is to be carried out, for example depending on whether a tank for cleaning fluid has been mounted. The areas that should not or may not be wet cleaned are determined using sensors or a map. A much more user-friendly option is to use an HMI (Human-Machine Interface) on the robot, at the service station or an HMI wirelessly connected to the robot to offer the user the choice of wet or dry cleaning. Thus, it would be conceivable that different areas of the robot's operational area are to be cleaned only dry, only wet, dry and wet or first dry and only then wet.

To differentiate between the different cleaning modes (wet, dry, . . . ), dedicated buttons could be provided or multiple button assignments could be used. For example, on the robot, a single press of the cleaning button could cause the robot to clean all dry cleaning areas and a double press to perform dry and wet cleaning. The same operating elements could also be provided on a remote control, e.g. a mobile phone, or on the service station.

The desired type of processing (cleaning mode) of certain areas could be set, for example, on the HMI in the map. For example, a simple press (e.g. click on a touchscreen) on an area on the map could result in a dry cleaning task being assigned to an area. A double press (double click) could assign a dry and wet cleaning task to the area, and pressing it again would enable further configurations (e.g. cleaning with higher power, speed, etc . . . ). Of course, in addition to multiple presses, it is also possible to assign long or short button presses and soft and firm button presses to certain processing modes.

Depending on the embodiment of the HMI, a desired processing operation could be started in the manner described above. For example, double-clicking on the station could result in the robot's entire area of application being cleaned dry and wet. A double-click on the robot could lead to a corresponding cleaning in the current room in which the robot is currently located. Clicking on a start button or double-clicking on an area of the map could result in the selected area being processed accordingly. Of course, defined no-go zones of the robot can also be taken into account so that e.g. carpets and other sensitive parts are treated according to stored specifications. Which gestures (e.g. double-click=dry, wet, long press=delete assignment) lead to which behavior can be preconfigured, but could also be designed in such a way that a user can configure this himself.

As stated, it is possible via an HMI (cf. FIG. 2, external device 300 can be designed as an HMI) to set whether an area is to be cleaned only wet or only dry or dry and wet (sequentially or simultaneously with a simultaneously active wet and dry cleaning tool). This is particularly advantageous if the robot has the option of regulating whether liquid from its tank should be applied to the wet cleaning tool or not. It is of course even more advantageous if the wet cleaning tool can be switched on and off (e.g. via a lifting function, i.e. by lifting of the tool). Unfortunately, previous systems make the function of their processing exclusively dependent on whether a wet cleaning tool is present or filled with liquid or not. If it is ready for use, the robot always conducts a dry and wet processing. If it is not available or not filled with liquid, only dry cleaning takes place and no wet cleaning takes place. The processing can be optimally individualized by the optional setting of wet and dry processing areas. In this way, individual areas, several areas (e.g. several rooms) or everything can be processed dry, wet or as desired. According to some exemplary embodiments, it is possible to first process those areas of a floor surface, which are not suitable for wet processing. If the wet cleaning tool is only moistened afterwards, faulty processing is even less likely.

With respect to work orders, the “clean everything” function takes on a special case. A complete cleaning of the robot's operational area is carried out through this function. Since many users make frequent use of this function, it makes sense to have a corresponding start button or another control element for this function via the HMI, with this control element either directly on the robot, on the (base) station or on a remote device (cf 2, item 300), for example, a smartwatch or other wearable device. When the “clean everything” function is called up, only areas that are also permissible for wet processing would of course be wet cleaned. In case of doubt, dry cleaning would be carried out or a query would be made to the user or subsequent information would be provided that a specific region was only dry cleaned for a specific reason.

In order to give the user the opportunity to check the type of processing that has been set, there is the possibility of causing the HMI or the robot to signal corresponding outputs by means of light or sound. For example, a blue light could signal wet cleaning and a yellow light dry cleaning. Error states could be signaled by a red light, for example. In this context, it should also be mentioned that previous robots that operate based on maps have no signal as to whether they are currently localized in their environment. It makes sense signal corresponding information to the user so that he knows the status of the robot and what reactions he can/must expect from the robot. One possibility would be, for example, for the robot to use a flashing light to signal that it is still busy (self-)locating. A continuous glow or a separate display could signal that the robot has located itself in the area of operation and is in a “smart” state. Similar signaling could indicate whether the robot is performing object recognition and whether this was successful.

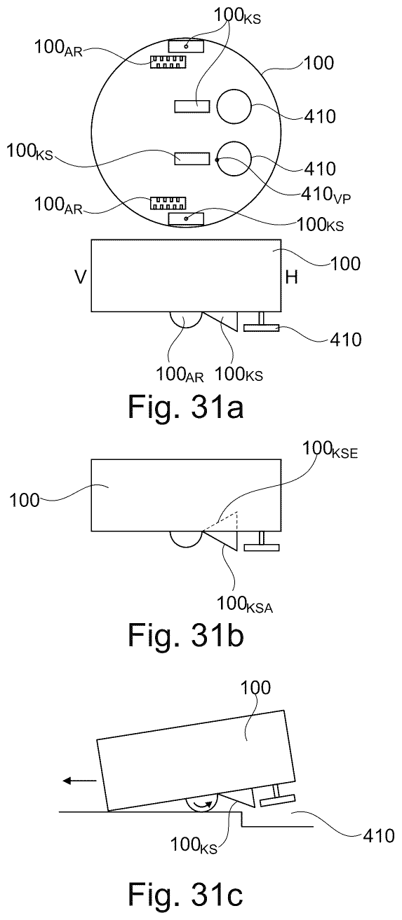

When processing the floor with wet cleaning units, it should be kept in mind that the wet cleaning tools can also result in the robot being stuck on them when driving under certain circumstances. This is particularly true when the wet cleaning tool 410 cannot be retracted, or can only be retracted slightly. One way to remedy this is to provide “climbing rails” (see FIG. 31, climbing rail 100KS) on the underside of the robot. Climbing rails can, for example, be wedge-like protrusions on the underside of the robot 100, which ensure that when driving forwards with the drive wheels (see FIG. 31, wheels 100AR) over a step, the rear part of the robot is lifted slightly. As a result, the wet cleaning tool is also slightly raised above the ground and does not get stuck as easily as it would without these climbing rails. Of course, the climbing rail (or several climbing rails) can be realized in different ways. FIG. 31 shows corresponding possibilities. The climbing rails should be designed in such a way that the foremost point of the wet cleaning tool is raised up so far that an edge/step lying ahead can be driven over without the wet cleaning tool colliding with the edge/step. In this context, it makes sense to use at least two climbing rails that are arranged symmetrically to the left and right of the robot's longitudinal axis (pointing in the direction of movement). Of course, more than two climbing rails (see FIG. 31a) or just one centrally positioned climbing rail are also possible. It is also possible to design the climbing rails 100KS so that they can be retracted. In FIG. 31b 100KSE symbolizes the climbing rail in the retracted state and 100KSA the climbing rail in the extended state. FIG. 31c illustrates the principle according to which climbing rails help overcome corresponding edges/steps.

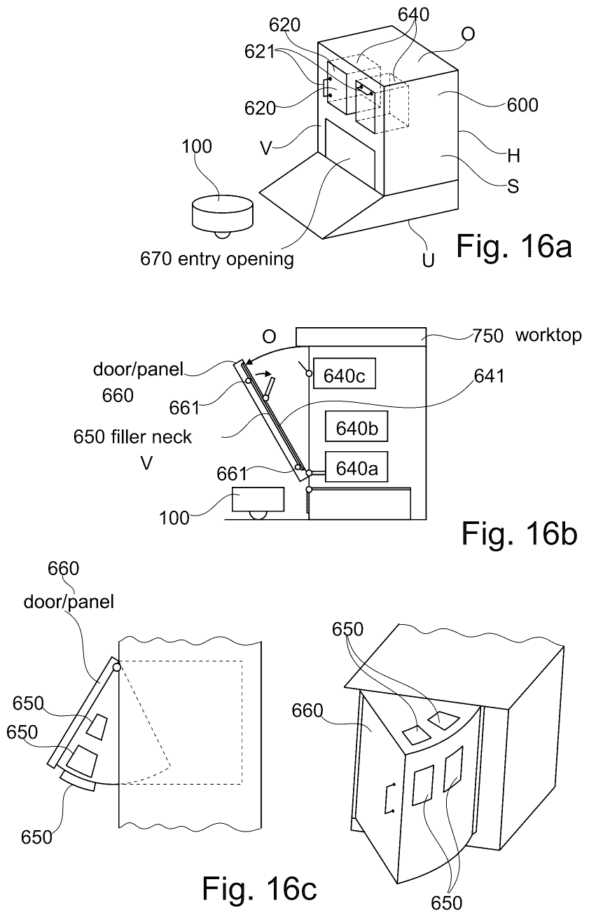

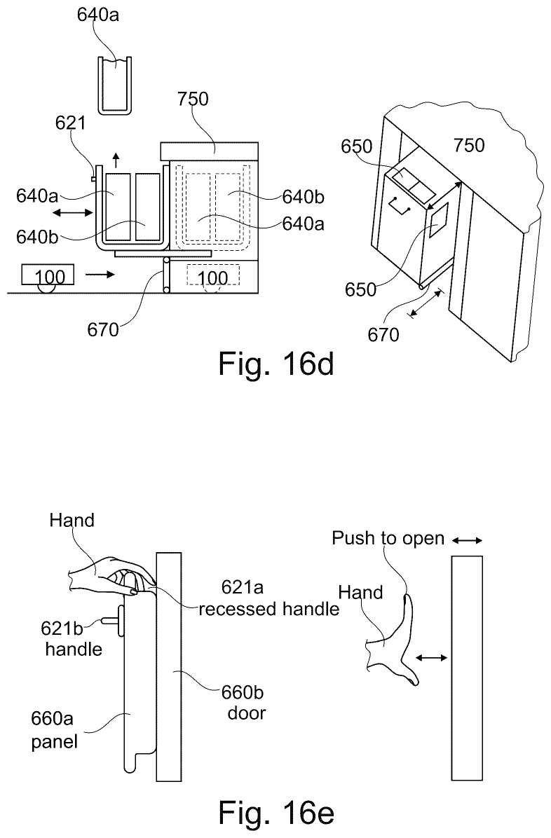

The previously described service station, which cleans the robot's wet cleaning tool, has one or more tanks (see FIG. 16, tank 640) which can store cleaning liquid, dirty water and/or vacuumed dust. Additional tanks can also be provided as an option, which, for example, provide additional cleaning agents, decalcifying agents or fragrances, disinfectants, etc. Previous systems are merely designed with water as the cleaning fluid. A separate tank system or a container in which, for example, detergent tabs for cleaning processes are made available is not yet on the market. In one embodiment, at least one additional tank with consumables is provided in order to make the cleaning system as low-maintenance as possible for the user.

For trouble-free operation, the corresponding tanks must be regularly maintained, for example filled, emptied or cleaned. In order to make the filling, emptying or maintenance of the tanks user-friendly, it is advantageous to be able to remove the tanks from the front of the service station. Known systems usually only allow filling from above or from the side. Especially with regard to the installation of a service station, e.g. in pieces of furniture or also in a wall as flush-mounted installation, refilling of the tanks or an opening mechanism for unlocking the tanks, which allows filling from the front (see FIG. 16a, front side V), is desirable. Since built-in service stations have their top O usually covered with furniture or worktops (see FIG. 16b, worktop 750), blocking access to the top for maintenance purposes. As mentioned, in one embodiment, the tanks of the service station can be filled directly from the front. In addition or as an alternative, it may also be necessary to move (displace, swivel, etc.) a part of the service station, such as a panel (see FIG. 16b, door/flap 660). For example, a part of the service station is opened from the front or towards the front, shifted, folded or tilted. After the forward movement, the tank can be filled from above, from the front or from the side at the filling area (see FIG. 16b, filler neck 650 for tank 640a). The filling area can of course have a lid. FIG. 16a-c shows possible variants of exemplary embodiments of a service station with one or more tanks that can be filled from the front.

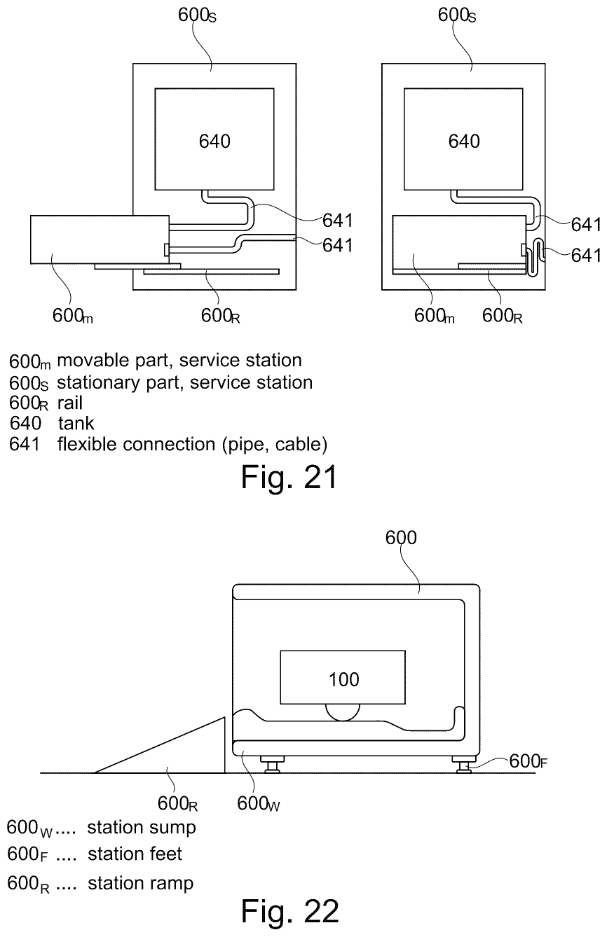

Various systems can be used to allow the opening of the tanks. For example, handles (see FIG. 16b, handles 621) or cavities can be provided on the front side or on its top, bottom or side surface. The same applies, of course, to possible paneling of the station. For example, the user can pull the handles 621 to open the door/hatch 660 for maintenance purposes. It is also possible to press inwards (FIG. 16e) in order to release a locking mechanism and then to open the door or flap (see FIG. 16e, door 660b). The opening movement makes accessible areas of the station, which then enable the user to fill, maintain or empty. On the one hand, this can be implemented in the mobile part itself (cf. FIG. 21, mobile part 600m of the service station) or on the other hand in the stationary part (cf. FIG. 21, stationary part 600s of the service station) of the base station. A filling in the moving part and a tank in the stationary part, which are connected by hoses (see FIG. 21 or 16b, hose 641), is also conceivable. In FIGS. 16a, 16b, 16d and 18, the identifier 670 designates the entry opening through which the robot can enter the service station in order to reach the service parking space of the service station 600. The service parking space refers to a parking position in or at the service station at which the service station can perform a service task on the robot (possibly in cooperation with the robot).

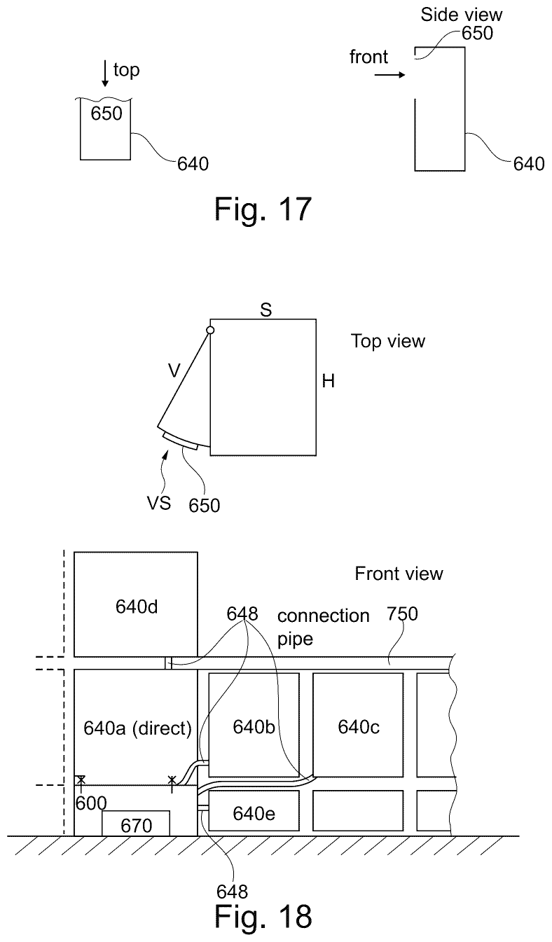

FIG. 17 shows possible filling variants. For example, filling from the front top but also from the front side is possible, with filling from the front top being preferable since this means that the lateral area can also be close to a wall, for example. This offers the advantage that the station can also be installed very easily in peripheral areas, e.g. the edge or wall section of a kitchen unit. The tanks or containers can be closed, for example, by closing the moving part of the station.

If the station is installed in a piece of furniture, for example a kitchen cabinet, it makes sense to design the front of the station in such a way that it can be clad with standard kitchen panels. So that the station can be built into pieces of furniture, it is advisable that corresponding assembly devices (see FIG. 16b, assembly devices 661) are attached or can be attached to the service station in order to connect the piece of furniture to the service station. It is also conceivable that parts of the service station are provided for attaching pieces of furniture or assembly devices 661. It is also conceivable that opening the kitchen fronts also opens the service station.

The advantage for the user of installing a service station is that unused areas in cabinets and cupboards can often be utilized. This also eliminates the free floor space required for a service station. The area around a free standing service station, that is difficult to clean, is also completely eliminated. This also increases the part of the robot's easy to clean operational area, since the area around the service station can usually only be cleaned inadequately by the robot itself.

Even if one decides not to install the service station into a piece of furniture or a wall, there is an advantage in filling from the front top. This advantage is primarily beneficial for the manufacturer of the system. A free-standing station can be designed in such a way that it is largely constructed in the same way as a built-in station. There would then be a built-in and a free-standing version of the station, which strong functional overlap. This makes it possible to keep construction and manufacturing costs as well as error rates low. A conversion set for a free-standing station to a built-in station can also be easily implemented.

In order to ensure a system that is as space-saving as possible, a suitable positioning of the tanks or containers in the service station is also provided according to some embodiments. It is thus possible for tanks or containers to be at least partially arranged higher than the tanks of the robot that are filled up in the station (cf. FIG. 18, tanks 640a 640d). This makes it easy to fill the tank in the robot with the help of gravity on the one hand and to provide large tanks relatively easily on the other hand. The size of the tanks is particularly important, as larger tanks require less user maintenance.

The installation of a station in a piece of furniture offers the advantage that any tanks and containers can also be installed in adjacent areas of the piece of furniture (e.g. kitchenette). For example, large tanks could be contained in an adjacent kitchen cabinet (see FIG. 18, tanks 640b, 640c, 640e). To be able to maintain these tanks it would of course make sense to have the same maintenance access as has already been suggested for the service station itself. The tanks could be filled directly or via hoses (see FIG. 18, hose 648) connected to the station. A shaping of the tanks or containers so that they can be installed in standard pieces of furniture, e.g. kitchen cabinets, is of particular advantage according to some embodiments. FIG. 18 shows possible variants.

From an ecological point of view, it is also useful according to some embodiments if the waste liquid is at least partially reused and is available again as a cleaning liquid, e.g. after filtering, sterilization or treatment.

If several tanks or containers are required for a service station, it can make sense to stack them on top of each other, as is shown, for example, in FIG. 16b (tanks 640a-c) or FIG. 18 (tank 640a and 640d). In this way, a clear and ergonomic system is set up for the user. Such stacking systems are not yet implemented and currently the different tanks are always lined up next to each other. These stacking systems are particularly suitable for stations that are not intended to be built into a piece of furniture. However, they can also be implemented in this case, e.g. by swinging a door of the piece of furniture to the side and thus allowing access to the containers from the front.

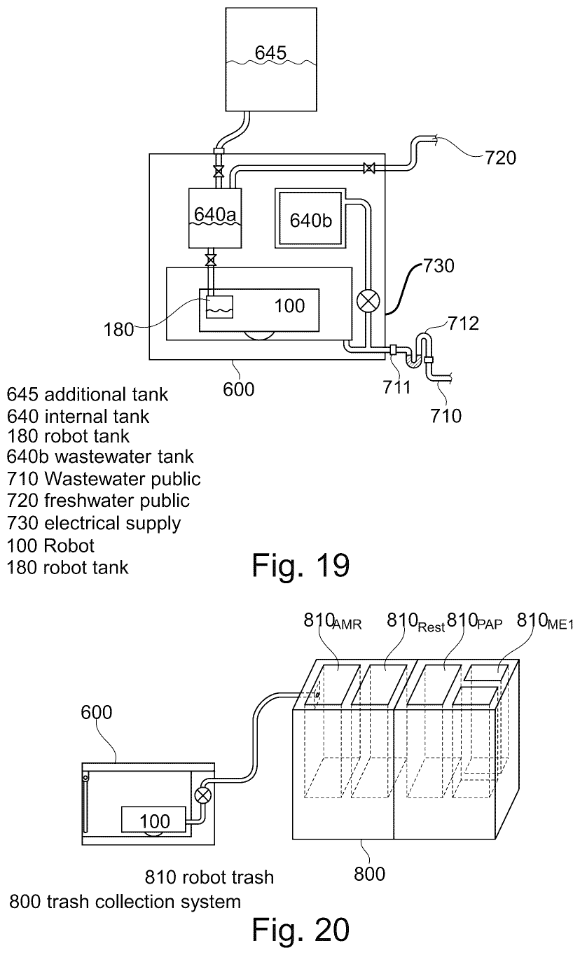

In the exemplary embodiments described here, the service station is intended to give the user the opportunity to operate a cleaning robot, while the necessary maintenance is reduced as far as possible. As already mentioned, the waste water that is produced when cleaning the wet cleaning tool can be disposed of not only into a waste water tank, but also directly into the sewage system (see FIG. 19, access to the sewage system 710) of the household or building. Of course, a connection to a siphon (see FIG. 19, siphon 712) is also possible for the waste water connection (see FIG. 19, connection 711). The addition of a waste water connection means that the necessary maintenance is again significantly reduced. Above all, emptying the dirty water is a maintenance job that users usually do not like, as it can soil them or the surrounding area.

As already mentioned, the fresh water could not only be made available via a tank, but could also come from the household fresh water connection. The same applies, of course, to the power supply to the service station. Another way to get fresh water is to use the moisture in the air. Condensed water could be collected in a tank by dehumidifying the air and using it for cleaning. In view of the amount of water required, however, it can be assumed that this variant will not be usable in all environments. To counteract this, it would also be possible here to reuse the waste water as a cleaning liquid via a recovery system, e.g. via a filter disinfection system.

In an environment with high humidity, however, this variant of water extraction from the air offers the synergy effect that water from tanks or the water supply is saved and the ambient air is additionally reduced to a humidity level that is pleasant for the user.

If the water is drawn from a tank or a fresh water connection, there is also the possibility of increasing the humidity of the environment. The service station would thus use a synergy effect that makes it possible to adjust the ambient air in a user-friendly way. It should also be mentioned in this context that an air washing function could also be integrated very easily here. This function could filter dust particles and impurities from the air by suctioning the ambient air and then passing the air through water. A reduction in germs in the air could be achieved by means of UV light. The service station can thus also provide an environment that is significantly more pleasant for the user.

In addition to the waste water connection, the supply of the station with fresh water from the public water network enables the wet cleaning system to be operated almost maintenance-free (see FIG. 10, connection 720 to the water network). If a dust extraction function and an optional cleaning function for the dry cleaning unit are also integrated in the service station, the user is less often forced to take care of waste disposal and the robot system can be operated with less maintenance.

In order to avoid overfilling the dust container in the station, the dust could also be disposed of via the sewage system (e.g. by flushing the dust away with the sewage). However, care must be taken to ensure that the dirt disposed of only includes parts that may be disposed of via the sewage system. This may require pre-processing, e.g. by filtering or sorting out unsuitable materials, or by crushing the dirt before disposing of it in the sewage system.

A supply of fresh water, waste water and electricity (see FIG. 19, connection 730 to the power grid) is particularly advantageous for the user. If—for example in a kitchen—there are other devices (eg dishwashers) that have such connections, one could also use connections of these devices according to some embodiments or these devices can themselves have connections for connecting a service station. A connection to a dishwasher or a washing machine would be of particular interest. Both devices usually have all the relevant connections and could also make these available to a robot's service station. A complete integration of the service station into such a device such as e.g. a washing machine or a dishwasher would be advantageous. In this case, the service station could, for example, easily retrieve hot water from the devices. Although this could also be accomplished without complete integration, it would be significantly more complex, since, for example, the provision of hot water would have to be routed via external interfaces and corresponding synchronization would be necessary.

Additional synergy effects result when the service station is integrated into a dishwasher or, for example, into a washing machine. In the future, a robot could, for example, also bring dishes or laundry to the device or transport them away from it. Of course, other devices or apparatuses are also conceivable. The robot could also be connected to a sink, which usually does not have a power connection. A refrigerator or an oven would also be conceivable, although these often do not have fresh water and waste water connections.

Depending on the circumstances of the area of application, it is easier or more difficult to supply the service station with fresh water or wastewater disposal. In some exemplary embodiments, the service station is therefore constructed in such a way that corresponding tanks (640) or conversion sets can also be connected to it as an option. In this case, the service station would have to allow operation from a tank, but not necessarily require it.

In washing systems, it is also possible for the wastewater to be examined for its composition. Appropriate sensors could, for example, carry out a chemical analysis of the wastewater and notify the user if there is any interesting information. Above all, the detection of toxic material in wastewater would be particularly interesting for this application.

In general, it is advantageous for the user if the robot station does not stand freely in space, but is integrated, for example, into a device such as a washing machine, a dishwasher or in a kitchen cabinet, e.g. under a sink. As a result, the robot and station are no longer visible and cannot be accidentally operated by children or pets. The previously mentioned soiling in the area of the service station is also reduced in this case. Emptying the dirt container of the robot is also unpleasant work for the user. Since he has to check whether the container is full and if necessary, empty it into the residual waste.

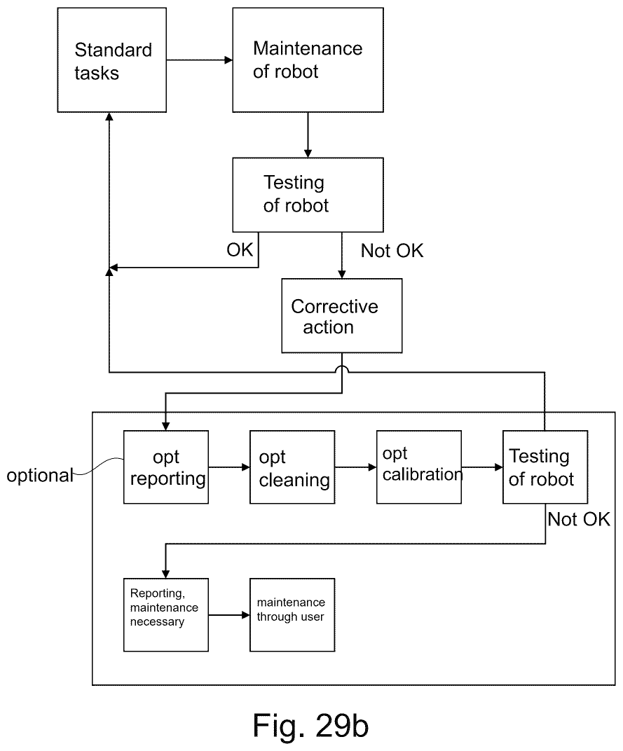

For the user, some points can be simplified. For example, a message can be sent to the user if a container needs to be emptied, or the robot can drive to a point in the operational area that is, for example, near the residual waste bin or is particularly suitable for emptying. This approaching and staying at a particular point (see FIG. 29a, point PI) can also be used for servicing of the robot or the station. For example, one or more service points could be entered in the map, at which a service could then be carried out by the user. Approaching a service point could be triggered both by the user (e.g. wirelessly or via an HMI) at the station or the robot, and by the robot or the station itself.

However, a particular advantage results if the robot can also vacate waste in the service station and is not only charged with consumables or energy. In the case of a dry cleaning device, for example, collected dust can be emptied, or in the case of a wet cleaning robot, the tanks can be emptied and the cleaning tools cleaned. As already described, it is of course possible to dispose of the dry waste with the waste water in the case of combined dry and wet cleaning.

An excellent location for accommodating a service station is, for example, directly under or near a sink. In this way, a space could be used that already has a water supply and sewage connection in the immediate vicinity. There is often a power outlet nearby as well. It is thus possible to provide all necessary resources for the service station. In addition, it is often common in households for a waste bin to be integrated in this area of a kitchen or bathroom. This makes it possible to use the space of a trash can for the base station and, under certain circumstances, to continue using parts of this space as a normal trash can for manual operation. The possibilities of combining a standard trash can 810Rest and a robot trash can 810AMR will be discussed in more detail later (see FIG. 20).

In the event that the service station is integrated into a piece of furniture or another piece of equipment and the entrance area is equipped with a door, there are several further advantages. For example, the door offers the possibility of reducing the noise of the emptying process that can be heard from the outside. Previous service stations with an emptying function stand freely in the room and when emptying into the station, an unpleasantly loud noise is produced. Another advantage is that dirt particles sometimes escape during emptying and soil the apartment. When emptying in a service station that has a door system or a similar contraption, both the volume and renewed soiling during emptying can be significantly reduced. If the service station also has a wet cleaning function for parts of the robot, it can also be ensured in this way that the living space is not affected by liquids. Furthermore, with a little extra effort, this also gives the possibility that the station can clean itself inside.

In the case of a dry-only dirt emptying, there is the possibility to provide a large dirt container in the service station, in which the dirt of the robot can be extracted and collected. If the station is integrated into a piece of furniture or into a wall, for example in the form of a flush-mounted installation, it would be possible to connected to an existing vacuum cleaning system, which in some houses is already built into the walls. With furniture integration, for example in a kitchen, there is also the possibility of emptying the dust directly into a trash can. On the one hand, this could be done directly in the residual waste bin 810Rest or, on the other hand, in a separate robot waste bin 810AMR, which is integrated, for example, in a waste collection system (see FIG. 20). In addition to residual waste, organic waste, waste paper, glass, metal and plastic, the waste collection system would then also have a robot waste compartment. For the user, this has the advantage that the robot waste no longer needs to be taken care of separately, but that the waste can be disposed of in the same way as other types of waste. A separate emptying of the robot or the service station is no longer necessary. FIG. 20 shows the emptying of a robot at a service point or in a garbage collection system.

In the event that the garbage is collected in a container of the station, similar considerations arise as in the case of built-in tanks 640 for supplies. If waste collection systems or supply tanks are integrated into furnishings, care must be taken to ensure that emptying or filling is as user-friendly as possible. For example, a dirt collection tank could be integrated into the service station, which is integrated in a similar way to the tanks for consumables described above. For this, too, operation from the front or above is to be preferred, as can be seen in FIG. 17

A connection to a dirt collection container is of course possible via appropriate hoses. In order to reduce the risk of clogging or to reduce the suction power unnecessarily, attention must be paid to sufficient diameters and short lengths. A collection of the dust is therefore preferably located right next to or above the service station. If the dirt container is not filled via a connecting hose but collected directly in the station, an area should be provided which is as easily accessible as possible and enables emptying. For example, an area to the left or right of the robot entrance could be used to remove a dust container with the same frontal removal system shown in FIG. 17. It would also be conceivable that the station or parts of it can be pulled out and thus provide access to the waste collection container.

Pulling out all or part of the station 600m has the particular advantage that it also allows for easy maintenance. In one exemplary embodiment, not only can the tank system be pulled out, but also, for example, that part of the service station that is used to clean the robot. In this way, for example, an integrated station can be maintained more easily. This can be done, for example, by a system with rails (see FIG. 21, rails 600R). This makes it easy for the user to remove dirt or blockages or to change sieves or filters in the station. FIG. 21 shows an example of such a structure in which a movable part 600m of the service station can be pulled out of the stationary part of the service station 600s like a drawer. Care must be taken to ensure that the required supplies, for example for electrical energy or fresh and waste water, is connected with flexible supply hoses 641 or cables in order to ensure proper functioning and safety against leaks despite the resulting movements.

It is advantageous if an installed service station has a floor or, even better, a sump 600w, as shown in FIG. 22. In particular, it is advantageous if the robot drives onto a sump that is in turn completely integrated in a kitchen cabinet. In the case of a service station with a water connection, the water from cleaning processes could also be collect there. On the one hand, the service station does not bother the user because it is installed and, on the other hand, it is constructed in such a way that it can safely service the robot when installed. Another advantage is that the interior of the service station can also be cleaned more easily. Especially if the service station can also be pulled out. Especially if intended for moisture or liquid applications, an integrated floor or even better an integrated sump is extremely helpful. They can be used to ensure that the floor is not damaged by leaking moisture. In this context, we would also like to point out the possibility of monitoring the humidity or leaking water using a sensor and/or using an appropriate Aquastop hose.

Furthermore, it makes sense to equip the service station with height-adjustable feet (see FIG. 22, adjustable feet 600F) in order to enable the station to be aligned horizontally. This alignment is of particular importance at service stations that contain liquids. Furthermore, the feet can be designed to absorb vibrations in order to minimize noise during washing and emptying processes. Using the feet, it would even be relatively easy to set up an “active noise canceling” system by integrating small actuators, e.g. piezo actuators, into the feet or their suspension. This could reduce cyclic vibrations and thus noise.

Since the robot usually has to overcome a height (at least the sump height) when driving into the interior of the service station, it is expedient to provide a corresponding approach ramp (see FIG. 22, ramp 600R) for the robot. In one embodiment, the approach ramp of the service station is designed in such a way that it can be extended or folded out or retracted or folded away. It would then not only serve as a ramp, but also as a door or gate for the robot.

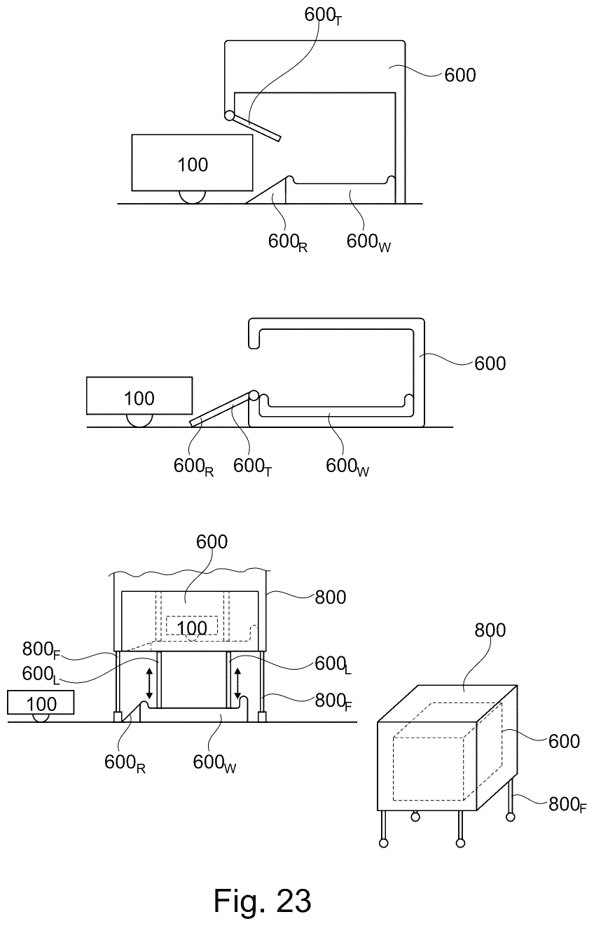

In general, it can be said that a door/gate (see FIG. 23, door 600T) of the service station makes sense for the robot, since this prevents soiling of the interior of the service station. A lifting system (see FIG. 23, lift 600L) would also be possible, which enables the robot to be lifted after it has entered the service station. FIG. 23 shows various door, gate and lift systems according to different embodiment examples that allow the service station to be closed. A door also makes possible that the noise pollution that the service station can cause can be significantly reduced.

Since a door, gate or lift system has to be moved, energy is also required in order to be able to carry out the movement. Furthermore, it may be necessary to ensure that the service station door and the robot are synchronized. The energy to open the door could come from the service station's electric motors, for example, or it could also be generated by the robot's kinetic energy. For example, the robot could press buttons or levers on the station and, for example, trigger the opening of the door by pressing a button. Through rotation of the drive wheels in the service station, for example, spring systems can be pretensioned, the energy from which can then be used for opening or closing processes. A particularly simple system of an opening and closing system is created when the robot drives through a hanging flap, which opens when driving through. Gravity or springs could then move them back to their original position. With such systems, care must be taken to ensure that the contact surfaces on the robot and on the gate are not heavily worn in order to avoid scratches. In one exemplary embodiment, the contact surface of the robot is made from a material that is more scratch-resistant than the door. This keeps the robot scratch-free and any scratches appear on the door. Since this is usually not clearly visible, this will be the lesser of two evils. Furthermore, self-healing materials can be used or wearing parts can be designed to be exchangeable.

In the event that electric motors drive the closing mechanism of the service station, it must be ensured, as already mentioned, that synchronization with the robot takes place. For example, the robot could send a signal when it wants to open or close the door. It would also be conceivable, however, for it to drive to certain positions in front of or in the service station and the station to use sensors to recognize that the door should be opened or closed. The door, gate or lift system of the service station could also be opened if the robot sends a corresponding signal to the service station. The service station can also be prompted by a signal to open, unlock or close the door, e.g. when the robot is in a defined position, in particular in a position in an area in front of the service station or in a decoupling position within the service station e.g. if one of the robots touches a stop or charging of the robot is detected.

The service station can also be constructed in such a way that the door, gate or lift system closes when the robot sends a corresponding signal to the service station or a certain time has elapsed after opening. It is also possible to detect that the robot has docked onto the charging contacts to charge the battery (and the door is therefore closed) or that the robot has left the charging contacts (and the door is therefore opened). It makes sense that access to the service station will normally be closed, as this makes it difficult for the interior to get dirty. The door is therefore only opened for the entry or exit of the robot and then closed again. Opening and then closing the door can of course also be implemented very well with a time control. Of course, combinations of mechanically and sensor-initiated opening and closing processes are also possible. Any exceptions, e.g. for service work by the user, must of course be taken into account.

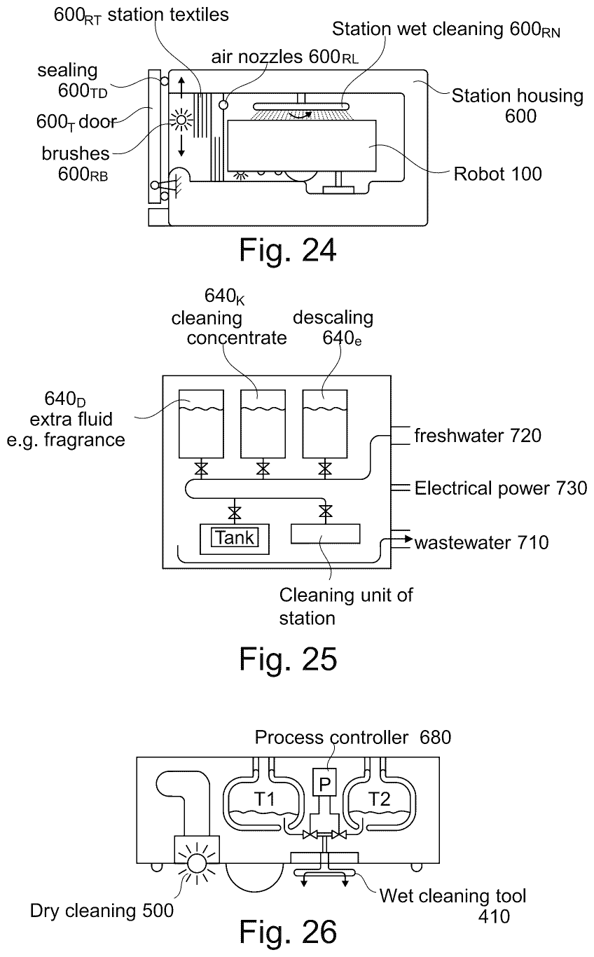

Of particular advantage is of course a service station with a door or another locking system that is constructed in such a way that it is hermetically sealed after the service station is closed. Although this can also be implemented using a service station that consists of two parts, e.g. a functional service station and a separate door, it is easier to implement if the door and functional part are permanently connected. In a hermetically sealed service station, the robot or parts of the robot could be cleaned with moisture particularly thoroughly, since during the cleaning process no water or moisture can escape from the interior of the service station and no damage to furnishings can occur. Cleaning brushes 600RB, air nozzles 600RL, or wet cleaning nozzles 600RN that are either mounted in a fixed or in a movable (e.g. rotating) fashion could be used for cleaning, as shown in FIG. 24. Furthermore, this would have the advantage that due to the more intensive cleaning, a certain self-cleaning of the service station could also take place at the same time, which again significantly reduces the maintenance effort for the user. FIG. 24 shows such a system.

As mentioned, integration into built-in appliances (e.g. dishwasher) is particularly suitable for such a service station. However, if a solitary device is to be installed in a kitchen, devices with the following maximum dimensions are particularly suitable: height 12 cm, depth and width 60 cm. This means that integration in the lower area of standard kitchens is easily possible and in most cases only unused space in the living unit is occupied by the station or robot. In this case, any tanks must be smaller or could be connected in a flexible manner as shown in FIG. 18.

As also already mentioned, service stations can provide bins or reservoirs that contain additional consumables that can be made available to the robot. Of course, this also applies to service stations, which also have a water tank. The advantage here is that the water can be pre-conditioned accordingly for use in the station. For example, cleaning liquid could be added to the cleaning water used to fill a robot. It is also conceivable that the composition of the mixed liquid is varied depending on the application. For example, a cleaning liquid for tiles could have a different composition than is desired for a wooden floor. It would also be conceivable for the robot to suggest a corresponding composition or to use a composition that was programmed by the user. A suggestion by the robot could be created, for example, after the robot has checked the area of application and has taken the corresponding circumstances into account. FIG. 25 shows options for using additional consumables such as fragrances (FIG. 25, tank 640D), cleaning concentrate (FIG. 25, tank 640K) and descaling agent (FIG. 25, tank 640e) as well as options for preconditioning liquids (e.g. adding detergent to fresh water).

In addition to the mixing ratio of, for example, cleaning agent and water to the appropriate cleaning liquid, there are other options available. For example, the liquids could be brought to a specific temperature, e.g. by heating them up using a heating coil. A disinfection of liquids would also be conceivable. This can be done chemically, e.g. with disinfectants, on the one hand, by increasing the temperature or by irradiation with e.g. UV light. This would make it possible, for example, to provide germ-free cleaning fluids.

Of course, applications in which the robot draws consumables from storage containers are not limited to use with cleaning robots only. It could also be applied to robots that oil wooden floors, distribute insecticides in rooms, undertake transport trips or enable multimedia applications. Of course, combination devices are also conceivable, in which different applications are combined.

Of course, the possible use-cases multiply with each additional consumable. Thus, cleaning salt, detergent, descaler (FIG. 25, Tank640e), nanosilver, fragrances (FIG. 25, Tank 640D), tea and so on could be provided. For people who believe in the effects of special stones, crystals or materials, areas could also be made available that would, for example, be flushed with water. In this way, an additional group of customers could be addressed and a kind of placebo effect could probably also be achieved. Of course, you could also use consumables from other devices, e.g. the rinse aid could be taken directly from the dishwasher. In this case it would also be easy to obtain hot water.

This would make it possible not only to use the robot or its accessories such as the Wet cleaning tool, but also to clean the service station itself. Different cleaning programs could also be offered, which differ in terms of their type (wet cleaning tool, sensor areas of the robot, parts of the service station . . . ), the time required (e.g. quick cleaning) or the thoroughness. Depending on the design of the system, only specific parts of the robot or the station, or optionally the entire interior including the robot, can be cleaned in the service station. This would ensure cleaning of the entire robot, including the interior of the service station.

For many applications, the liquids would be mixed in the station and the consumable liquid would then be transferred to the robot's tank. However, it is also possible for the robot to have several tanks and for the mixing or chemical or physical processing to take place in the robot. In order to save resources, the amount expected to be required for a work order could also be determined in advance and only the required amount filled/loaded into the robot. Of course, there should be a certain safety margin so that the work order can very likely be processed without an unforeseen return trip to the service station.

In some exemplary embodiments, the robot is designed to determine which tank contents are to be used in which application area. Based on this, the robot or the service station can determine whether and how the contents of the tank should be mixed. This has the advantage that the right mixture is immediately available on site and it is not necessary to return to the service station again. This would be a good approach, especially with heated water, since, for example, the temperature can be set very well by mixing cold and warm liquids (see FIG. 26, T1, T2). Although heating the water in the robot is possible, it would place a heavy load on the robot's energy storage system, which is why a liquid mixing system in the robot seems better for setting the desired temperature.

If heated liquids are used, it is of particular benefit if the tanks in the robot have low thermal conductivity. This could be made possible, for example, by using double-walled tanks (with an evacuated area between the walls). In this case, a heating system would also be interesting, since a heat-insulated tank that is already filled with warm liquid only needs to be reheated a little to keep the temperature constant. It would also be a good idea to thermally insulate the tank in the service station, as future devices will need to be more and more energy-efficient in order to enable resource-saving applications. FIG. 26 shows ways to use thermally insulated tanks.

By supplying the service station with consumables (e.g. via tanks in the station) the required user interaction can be significantly reduced. The service station does not necessarily have to have integrated tanks, but could also be seen as an arrangement as shown in FIG. 18, which on the one hand includes a module that performs the service task (e.g. washing the wet cleaning unit, filling the robot tanks, emptying the wand containers, etc. by the service station 600) as well as modules (e.g. tanks) that are available for consumables or waste materials. Nevertheless, at some point even a large tank or container with consumables will be empty. In this case, it is of particular advantage if the user is signalled that refilling is necessary. This can be done, for example, by means of acoustic or optical signals on the robot and/or on the station and/or by messages to the HMI, for example a smartphone with which the system is operated. Corresponding sensors or mathematical models that estimate the consumption of the material can be used to estimate the fill level or the presence of minimum quantities. It would even be possible to expand the system in such a way that it automatically places an order for new material if the amount of consumables is too low (i.e. if the quantity falls below a minimum).

In addition to the consumables, the service station could also provide or exchange entire cleaning units or robot components. For example, a station could store several batteries and change them if necessary. A waiting time during which the robot's battery is charged could be eliminated and the overall cleaning time could be significantly reduced. While the robot completes the work order with a charged battery, the discharged battery could be recharged in the station. The same would be conceivable for warm water tanks. Similar considerations lead to an embodiment in which the robot exchanges entire cleaning systems. It could then, for example, be converted from a dry to a wet cleaning device or changed to a floor treatment (oiling) robot. It is also conceivable that the robot uses several cleaning tools of the same type, for example 2 wet cleaning tools, one of which is used on the robot while the other is prepared for the next use in the service station, e.g. by being freshly cleaned and possibly also dried.

At the beginning of this document, the advantages that result from the cleaning of a wet cleaning tool in the service station were mainly discussed. As already briefly mentioned, a service station can also be designed in such a way that it is also able to clean the robot itself. During a work order, the latter can become soiled itself, since it is traveling in soiled areas and parts of it come into contact with dirt, which then sticks. Usually, the robot does not have a cleaning device for itself, which can lead to heavy soiling over time To remove this the robot needs to be cleaned manually by the user. Of course, this is an activity that users are reluctant to carry out. The soiling of the robot can therefore take on a considerable degree and increase up to its inoperability. Even permanent damage cannot be ruled out in such cases. The main problem here is dirt that accumulates in joints, wheels, bearings, brushes and sensors. In the case of wet cleaning robots, this soiling problem is more severe, since the dirt can mix with moisture and sometimes stick particularly well.

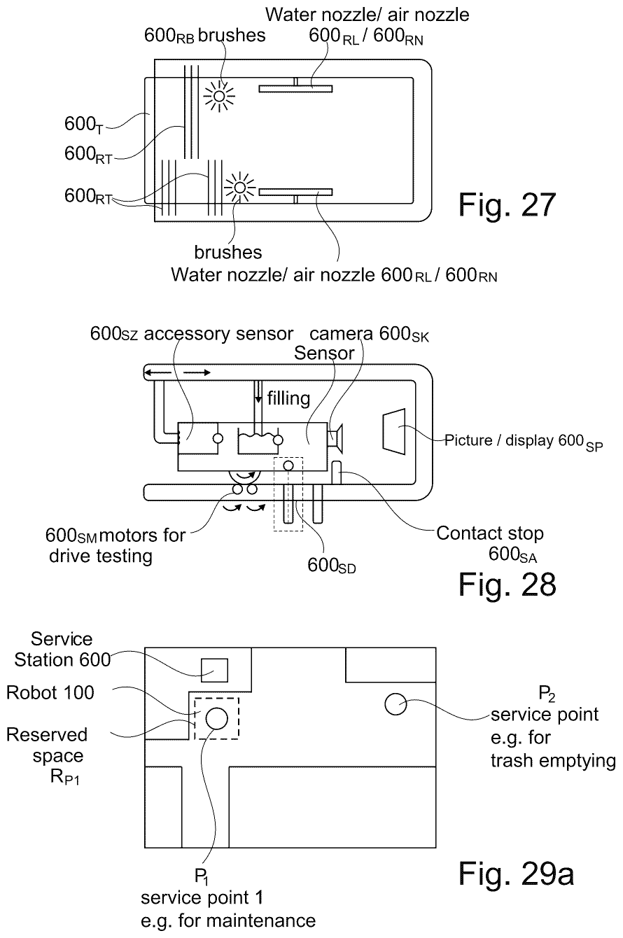

In this case, the service station, in particular a service station with a wet cleaning device, can solve the problem addressed by cleaning the robot. At the same time, the service life of the robot and thus customer satisfaction increases. The robot itself could be cleaned dry, damp or wet. With dry cleaning, for example, the robot itself could be vacuumed or cleaned by brushes, which can optionally also rotate. Cleaning with compressed air would also be possible. The robot would only have to drive past nozzles 600RL, 600RN, or brushes 600RB that are installed in the service station (see FIG. 27). Textiles 600RT, which are installed in the service station and wipe over the robot when entering and exiting, act as a possible cleaning device. Above all, cleaning with spray water would be very efficient, especially if it was heated beforehand, or with damp brushes. Different systems could also be combined here. Cleaning could, of course, be carried out from all accessible sides and also target specific areas. FIG. 27 shows different options for cleaning devices for robots.

In the variants presented so far, the housing or the surface of the robot is primarily cleaned. This makes a positive impression on the user and is above all advantageous because it cleans many surfaces that are necessary for the correct functioning of the robot's sensors. Especially, the robot's underside and the robot's front are particularly relevant in this context. Although they are rarely looked at by the user, they often get dirty. In addition, there are often a large number of sensors on the underside of the robot.

But there is also the possibility of cleaning the inside of the robot. For example, cleaning tanks or dirt containers could be flushed with air or cleaning liquid. A subsequent drying process would also be possible, in which the moist air is pumped out and dry air is introduced. Such drying would work particularly well in combination with heat.

In addition to the possibility of cleaning the robot in the service station, as already mentioned, it is also possible to check the functionality of the robot in the service station. For example, sensors could be checked for their functionality. Autonomous mobile robots possess numerous sensors. These include distance sensors (e.g. ultrasonic, triangulation, or time-of-flight sensors), bumpers (contact sensors or pressure sensors that detect when the robot touches a wall), wheel-drop sensors (which for example, react when drive wheels are no longer in contact with the ground), cameras (which check different areas (floor, surroundings, ceiling)), floor type detectors, inertial sensors (to check mechanical movements), current sensors (e.g. to check the drive-units of brushes, fans, etc.) cliff sensors, etc.

In the case of bumpers or proximity sensors, for example, contact stops 600SA could be arranged in the service station, which are approached by the robot in order to check whether the robot sensors actually detect a collision. In the case of the cliff sensors, pits (see FIG. 28, pit 600SD) could be used to verify that the robot successfully detects the pits. In the case of cliff sensors that work with reflected light, highly light-absorbing areas at the service station can be used to check the sensors. In this case, the sensors react to the fact that too little light is reflected. Mirrored areas would also be suitable for cliff sensors, since a mirror has practically no scattering and a system can be designed in such a way that practically no light returns to the cliff sensor. In the case of motors, a typical motion profile could be started and the motor currents that occur could be checked (FIGS. 28, 600SM). Level or positioning sensors could also be checked by intentional filling, emptying, decoupling or coupling (FIGS. 28, 600sz). Even camera sensors 600K can be checked by applying test images. FIG. 28 shows possible systems according to some embodiments with which sensors of the robot can be tested.

For corresponding tests, the inside of the service station would of course have to be equipped with appropriate stops, light/dark markings, images (FIGS. 28, 600SP), or mechanical movement options. A screen or a projection could also generate these markings and cover numerous use cases in this way. These or other markings and devices in the service station could also be used to recalibrate the robot's sensors.

As already mentioned, the robot could make itself available for maintenance at certain positions (maintenance points) in the operational area that are marked in the robot's map. Such a maintenance point is particularly advantageous if the user wants to have the robot move from the service station to a maintenance point. For example, the robot 100 could be moved from the station 600 to the position PI as shown in FIG. 29a. A special maintenance mode of the robot is also available for this purpose, which ensures that all information of the mechanically and electrically relevant parts are made available to the user via HMI.

The maintenance point or service point P1 or P2 from FIG. 29a of the robot can either be set automatically and, for example, be in the vicinity of the service station or, for example, also be freely selected by the user on the map. In the example shown, the maintenance point is in an area that allows enough free space RP1 around the robot to ensure easy maintenance and easy access to the robot. For example, a free area that appears particularly favorable due to object recognition or other attributes can be automatically selected as the standard maintenance point. For example, a wet cleaning robot could give preference to a tiled floor for servicing the wet cleaning unit, or drive to a service point in front of the household waste to empty the robot waste bin.

It would be of particular advantage if, in the case of maintenance, the robot would already start a self-diagnosis when driving to the maintenance point or initiate it at the maintenance point. The robot could already provide the user with useful information at the maintenance position. It would also be conceivable for the robot to be tested and/or cleaned in the station, for example FIG. 29b illustrates one possible method. The robot performs standard tasks, e.g. cleaning. After this standard task, the robot carries out a service in the service station and can be cleaned in the station, for example. A subsequent diagnosis of the robot ensures that it is operational again. If this is not the case, troubleshooting or information can be provided. For example, the sensor areas could be cleaned again or the sensors could be calibrated. Optionally, the user could also be informed about this. If the error cannot be rectified after one or more troubleshooting attempts, the user will be informed and/or a service or maintenance point will be approached. FIG. 29b shows a possibility of maintenance and cleaning, testing, diagnostics and calibration.

A self-diagnosis can also be carried out cyclically and does not necessarily have to be carried out in the service station. Even while performing the standard task, a robot can come to the conclusion that not all sensors are in the desired state. In this case, the system could decide that the robot should be cleaned or tested in the service station and take appropriate action. Of course, the desired order or sequence of (diagnosis/test/cleaning/maintenance/possibly calibration) could also be designed to be configurable by the user.

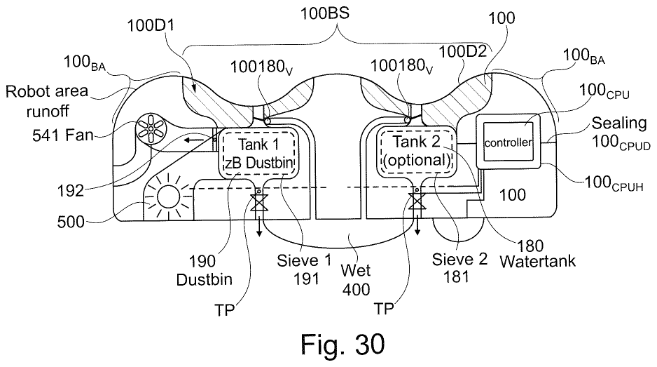

In one embodiment, the entire robot is splash-proof and can be washed, for example, in the service station. You could then also wash the robot in a dishwasher, for example, or set up the service station similar to a dishwasher. To do this, it is however necessary to design the robot in such a way that it (or at least its sensitive parts such as the control unit) is splash-proof and fully functional again as soon as it has dried. FIG. 30 shows an embodiment of such a robot. The robot has a cover 100BA which is constructed in such a way that water cannot penetrate into the controller 100CPU, at least from above. Of course, it is even better if the robot is constructed in such a way that the controller sits in a cavity 100CPUH, which is hermetically sealed with seals 100CPUD, making it watertight. Of course, similar cavities could be provided for other parts of the robot that are sensitive to moisture, such as sensors, wiring harnesses, mechanics, etc. Parts that cannot be constructed in such a way that no liquid can get into relevant areas (e.g. drive wheels and their bearings) must be constructed in such a way that they are protected as well as possible (e.g. by labyrinth seals or similar) and that a full functionality is restored after drying.

In the case of cleaning with liquid, it is advisable to charge the robot by means of induction in order to avoid any short circuits during the charging process. The possibility of inductive charging is of course not only limited to splash-proof robot-service station combinations, but can also be used in other cases.

The same applies to a wet suction nozzle. This is generally an advantage for a cleaning robot and allows the suction of wet particles. However, the design and production of such a system is significantly more complex and expensive than that of a conventional dry vacuum nozzle. However, in the event that the robot is set up in a splash-proof manner, it is particularly useful. Ideally, for a splashproof robot, ensure that the top surface of the housing is shaped in such a way that water cannot spill into the robot.

Any collection areas on housing parts of the upper surface must be designed in such a way that water can also drain through them, since otherwise accumulations of water will form in the robot, which can damage it. However, it would also be conceivable to deliberately design certain parts to collect liquid so that certain tanks in the robot fill up during the washing process itself. This could eliminate the need for complex filling mechanisms such as coupling with valves for tank filling, etc.

For such a structure, it makes sense to equip the robot with closure systems that can close the tank at the top or bottom to allow the tank to be filled in a controlled manner. A valve could be used to control whether a tank is filled or the liquid drains off directly. In the case of cleaning, the upper valve would then probably be opened first in order to flood a tank. The lower valve could then be opened to dispose of the contaminated liquid. Of course, this process could also be repeated several times. When cleaning is complete, the valves could be set in such a way that the robot's tanks are filled with consumables for the standard task.

In general, it makes sense for robots that have a service station and enable comprehensive maintenance of the robot to design the water tank in such a way that it can no longer be removed. On the one hand, this simplifies the sealing of the robot and, on the other hand, enables a more compact design. Of course, it is not absolutely necessary for a robot to be waterproof or have a service station in order to enjoy all the advantages of a non-removable water tank or dust bin. The possibly more compact and cheaper construction, as well as the simpler overall structure and the correspondingly simpler operation benefit the user even without a service station or splash proofing.

It is of particular advantage, however, if the handling of the water tank on the robot or the wet cleaning unit, which is usually disliked by the user, can be omitted, which is typically possible with a corresponding service station. Nevertheless, the robot should be constructed in such a way that the inside of the tank or tanks are accessible. However, this would be easily accomplished with the help of a simple hinged lid and e.g. an optional handle.

The same applies in principle to the dust container (dust bin) of the dry cleaning unit. If this is emptied in the service station anyway, a dust container that can be removed is no longer necessary and can be omitted. Here too, however, it is expedient to design this in such a way that the user has access to the inside of the dirt collection area (see FIG. 30, dust container 190) if necessary, e.g. to remove valuables that have been accidentally vacuumed up or to carry out manual cleaning. Access via a cover (see FIG. 30, cover 100D1 [where?]) is also conceivable here. In both cases, access from above is usually the best option for accessing the dust container or liquid container for maintenance purposes. Furthermore, it makes sense that filters (see FIG. 30, filter 192) or sieves (see FIG. 30, sieves 191 and 181) are integrated, in which any larger particles that are in the dust container (see FIG. 30, dust bin 190) or supply tank (see FIG. 30, tank 180). These can be designed in such a way that they can be checked and/or emptied by the user.

According to some embodiments, the robots can have drainage areas at the lowest points (see FIG. 30, point TP) of their dirt collection bins or tanks, via which liquid can be drained or vacuumed off if necessary. The actuation of this drain can either be done by an actuator in the robot, but could also be done, for example, by a mechanism such as a stop in the service station.

In many of the examples discussed above, it makes sense that the robot is serviced at a station that at least partially encloses the robot. However, many of the options shown can also be implemented using a service station that does not require the robot to be enclosed. Some examples of this are checking or cleaning sensors, robot tools or robot areas (e.g. with brushes, air nozzles or similar). In the following, advantageous options are discussed that result from the maintenance of the robot at the service station.

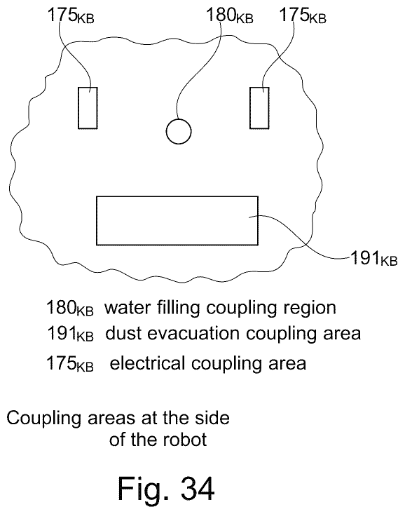

Some service functions performed on robots at stations relate to the exchange of materials (e.g. via hoses, ducts or the like), energy or information. In the case of energy or data exchange, the transfer can be either via an electrical cable or wireless. In the case of electrical cables, one or more contacts are typically connected to one another (cf. FIG. 34, contacts 175KB). In the case of materials, this can, for example, relate to the supply or removal of particles or liquids via hoses, pipes, channels or the like (e.g. cleaning liquids, dirty liquids, dirt).

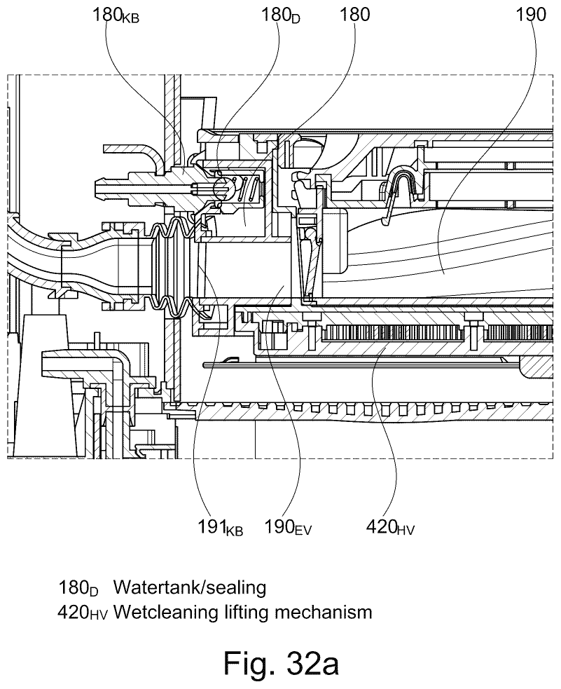

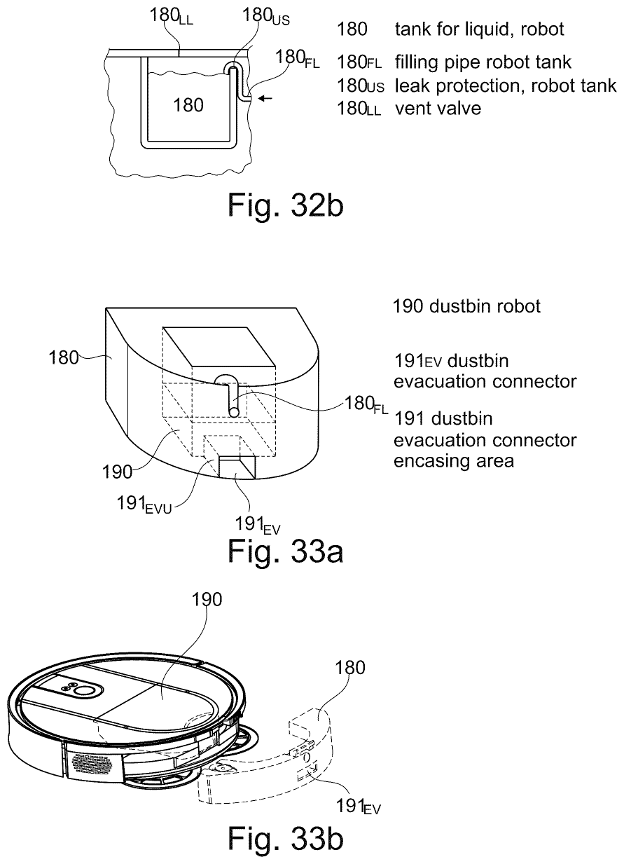

An example of a robot docked at the service station is shown in FIG. 32a. In order to be able to exchange the materials, the containers of the robot and the station must be connected to each other. Usually, connection pieces are used, which consist, for example, of pipes, seals and locking mechanisms. Depending on the consistency of the materials to be exchanged, the connection between the robot and the station must have the appropriate properties. For example, the requirement for tightness is greater for gases or liquids than for solids. While fluid (liquid or gaseous) materials can often be guided easily through small cross-sections or along winding paths, the transport of solids often requires a large pipe cross-section in order not to clog. The material connections between the robot and the service station are usually made by connecting a pipe from the robot and a pipe from the station at an interface, with a seal often also being used to prevent or at least reduce the leakage of material.

If several containers of the robot have to be brought together with several containers of the station, e.g. to pump liquid into the robot and vacuum dirt out of the robot, this quickly leads to design difficulties, since only limited space is available and also the correct alignment between robot and station can lead to problems with several parallel connections. This problem is often counteracted by coupling connections one after the other, i.e. a further coupling is only carried out when a previous coupling has been released. However, this has the disadvantage that more time is required. There are also solutions in which there are interfaces used for coupling to the service station on different sides of the robot. For example, it can be evacuated from below, filled from above and loaded from the side. In this case, however, the user has the disadvantage that, for example, maintenance or cleaning work has to be carried out on different sides of the robot. A parallel coupling (simultaneous creation of all couplings between robot and service station) would be preferable from the user's point of view

The coupling of the water supply, i.e. the connection of the pipes from the robot and the service station, can take place, as shown in FIG. 3, by driving the robot into the station. As already indicated, the movement of the robot can be used to establish other required connections/couplings between the robot and the station. In this way, the connection between the dust container in the robot and the dust container in the station can be established at the same time, thereby enabling the dust to be extracted from the robot. This eliminates the one coupling mechanism that requires the intervention of mechanical elements that are not directly in the direction of the coupling movement. Typical of such a system is, for example, dust extraction from below. It is often the case here that coupling elements are required, which are tilted or shifted when the robot enters, for example, in order to establish the connection.

Furthermore, with the concept described here, it is not necessary to couple from different sides or to use active elements that perform the coupling. In known systems, this is often solved in such a way that the coupling elements engage in the robot from different sides (e.g. top and back or front and bottom . . . ). This has the disadvantage for the user that in this case not all coupling elements can be checked at a glance. If required, he has to lift the robot and check the underside, for example, or look at the robot from different sides. Of course, it is also advantageous if the operating elements are attached to the robot in such a way that they can be checked with the same line of sight.

Furthermore, in the case of direct parallel coupling of the links, only the movement of the robot itself is used as the coupling movement to perform the coupling operation. There are therefore no additional actuators, coupling mechanisms or other mechanical elements required which, for example, actively move a filling nozzle or an outlet in order to carry out dust extraction from below or to enable liquids to be filled up. Such a coupling system is therefore less prone to errors and can be easily checked and maintained. Of course, this principle can be extended to other potential couplings such as a waste liquid suction, refilling of detergents or the like.

The coupling of electrical connectors, for example for charging or for checking electronics or sensors, could also be carried out during the approach movement of the robot. Of course, it is advantageous if the connecting elements have approximately the same coupling direction and the connections are designed in such a way that possible manufacturing or movement tolerances do not impair the coupling function. In order to ensure this, for example, a self-centering guide element can be provided for the correct alignment of the robot and the service station relative to one another.

As shown in FIG. 32a, this is achieved, for example, by the liquid filling nozzle and a conical recess on the robot side (see coupling region 180KB in FIG. 32a). The conical (e.g. truncated cone-shaped) nozzle is part of the service station and in this case is first centered by the conical recess during the approach movement and then inserted into the tank connector of the robot. Of course, the centering or alignment could also take place at a connection that is not intended for the exchange of liquids, but rather, for example, for the exchange of dust or energy. However, it is expedient to use a connection that requires a high level of tightness or connection quality. Furthermore, the protruding or centering element can of course be part of the robot as well as part of the station. As shown in FIG. 32a, a sealing ring 180D is provided in the tank connector. This causes a simultaneous seal when inserting the filler neck into the tank connector. The seal does not have to be on the inside of a pipe, but could also be on the outside or on the conical end piece or on the stop of an inlet or outlet pipe.

During insertion, the filler neck simultaneously opens a valve, which is formed by the same sealing element and a ball as shown in FIG. 32a, thereby enabling the robot tank 180 to be filled via the filler neck. This valve is optional and does not have to be present. However, it enables the robot tank to be filled up to such an extent that the maximum water level in the robot tank 180 is above the filling level. Furthermore, there can be an optional valve in the liquid pipe of the station, which is released due to the coupling.

In this way, the filler neck can be easily constructed and fulfills several central tasks. On the one hand, it facilitates the correct alignment between the robot and the station, enables a tight connection between the station pipe and the robot pipe and optionally unlocks valves that ensure that the water tank or the station are connected when coupled and closed when uncoupled.

In order to prevent the water in the robot tank 180 from leaking out through the filling pipe, a leak protection device 180us (as shown in FIG. 32b) can optionally also be installed in the water tank 180. The filling pipe 180FL is shaped in such a way that it is vented when the water level is falling. This is accomplished via a vent valve 180LL which allows air to escape as the tank 180 is being filled with liquid and through which air can be drawn in as the water level drops. This has the effect that no or only little water can escape from the robot tank 180 in the event of a defective valve. It is advantageous if the leak protection 180US is located as far up as possible in the water tank, since when the water is still the water can only flow down to the position of the leak protection 180US. However, even if the leak protection is structurally attached further down, it still offers protection against leaking of all the water. The station could also ensure that filling only takes place up to this level by vacating so much water out of the tank after filling until the filling pipe is vented. For example, the leak protection can be formed by a U-shaped tube segment through which—when it is filled with air—no water can leak. In the example shown, the U-shaped pipe segment runs over the top edge of a wall of the tank. The U-shaped pipe segment 180us can also be integrated into the wall of the tank 180.

The connection (the connecting duct 190EV) for extracting the dust or solid particles from the dust container 190 of the robot is achieved through a connection piece of the dirt container to the rear of the robot (see FIG. 32a). Since the water tank 180 can also be located at the rear, it is expedient according to some embodiments to guide the dust extraction connection 190EV through the water tank 180. The water tank 180 can therefore be constructed in such a way that it forms the connecting piece 190EV between the dust container 190 and the extraction area (interface/coupling area 191KB between service station and robot) (see also FIG. 33b) or at least partially surrounds the connecting piece (see also FIG. 33a) . It can thereby be achieved that the volume of the water tank 180 is reduced only minimally and that it can comprise a volume both to the left and to the right of the dust extraction connection piece. In this way, the tank 180 and the dust container 190 can be arranged at approximately the same height (above the floor) and the connection piece 191EV does not have to be routed past the tank 180, which enables better use of the installation space inside the robot. Furthermore, the interfaces 180KB, 191KB (see FIG. 32a) for the liquid and the dust can be arranged close to each other on the same side of the robot. This means that both the filling and the evacuation of the robot can be carried out from the same direction and a large tank volume can be made available.

FIG. 33a illustrates a possible embodiment of this connection 191EV, which is encased by a water tank 180. If it is not desired that the tank body is also part of the pipe or that the connection 191EV is completely encased by the tank 180, the tank body could also be constructed in such a way that the pipe 191EV for dirt extraction is at least partially encased. In this case, however, it should be ensured that liquid can be removed in such a way that no large amounts of liquid remain in the tank if it is emptied, for example during processing, or the like. In addition, care should be taken to ensure that the water consumption is similarly high on the left and right side, so as not to unnecessarily shift the robot's center of gravity. The main advantage of such an embodiment is that the robot can take up a lot of water to the left and right of the dust pipe 191EV and dirt can still be evacuated out of the dust container 190 to the rear. In order to make the extraction as energy-efficient as possible, the pipe 191EV from the dust container 190 to the service station can be kept as short as possible. In this case, the dust container 190 itself (and not just the connecting pipe 191EV) can be at least partially encased by the water tank. In addition, care was taken to ensure that the dust primarily travels horizontally and without steps on its way to the extraction station.

It is also possible that the robot or the station has a lock which is closed in the coupled state in order to ensure that the inlet and outlet pipes of the robot and station remain securely connected.

The robot can be supplied with electrical energy via charging contacts 175KB, which are arranged in such a way that they lie above and/or to the side of the water supply area 180KB (see FIG. 34). In this way it can be prevented that the water affects the charging contacts 175KB and e.g. causes short circuits between the charging contacts or corrosion. In this example, the charging contacts were therefore placed on a side surface of the robot. To maintain compatibility with other charging stations that typically charge a robot from below (i.e. the charging contacts are on the bottom of the robot), the robot may have alternative charging contacts that also allow charging from below. Of course, alternative charging contacts could also be attached to the station, e.g. to supply power to robots whose charging contacts are at the bottom. Of course, the double/redundant execution of interfaces can also affect other connections, e.g. to enable compatibilities or to provide alternatives if an interface cannot be used.

The charging contacts can also be used to exchange information between the robot and the service station. This allows the robot and station to receive the status and other information from the other device and respond to the corresponding status. For example, if only one device (robot or station) has a particular HMI (e.g., audio or connection to an external HMI), one device could communicate messages intended for the user to the other device. For example, the station could use the robot's audio system to acoustically report that water should be refilled or emptied. After receiving the information from the station, the robot can forward this information to the user via its HMI. Other possible information that is relevant for the exchange could be, for example, status or error messages from the devices, as well as user interactions or diagnoses to be carried out. Inconsistencies between sensors in the robot and station could be used to detect errors. For example, an error can be detected and possibly reported to the user if the station detects (by means of a sensor) that water is being delivered to the robot, but the relevant sensor of the robot does not detect any water intake. In addition, the robot could tell the station (or vice versa) which service functions (e.g. refill water/carry out dust extraction) or in which way the service functions should be carried out (e.g. through parameters for tool cleaning functions/duration or intensities of service functions etc.). Orders (e.g. cleaning orders) that a device has received from the user or other authorized entities could also be transferred from the robot to the station or from the station to the robot using this method.

Electronic data exchange between the robot and the service station offers numerous functions that are advantageous for the overall system. However, it requires the electrical data exchange described above or the possibility of a wireless data connection. Both are associated with additional costs and unfortunately also increase the susceptibility to errors in a system. Alternatively, the hardware status or the mechanical status of the devices could also be used to trigger corresponding actions. If, for example, there is no communication, a standard routine could be carried out due to the act of a robot docking. For example, as already described, the robot's dust container 190 could be evacuated (emptied) or the robot's water container 180 could be refilled. In order to actually start the standard task, other states can of course also be included as an option. For example, additional sensors could check whether certain components, such as the water tank, are present. The same applies to optional accessories, e.g. alternative cleaning tools, etc.

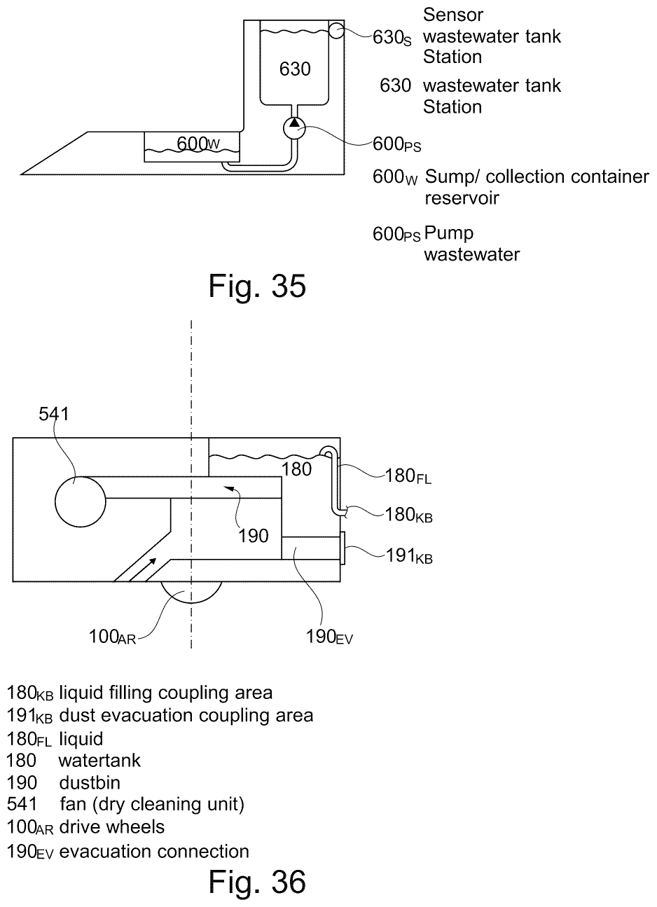

If the station is not connected to the public water supply network or water disposal network, the station can have fresh water tanks and dirty water tanks 630 in order to service the robot. To ensure that the station's dirty water tank does not overflow, a corresponding sensor 630s can check the filling level of the dirty water tank 630 and thus ensure that no further dirty water from a collection tank 600w (drip tray, tub) located in the station is pumped into the dirty water collection tank 630 (see FIG. 35, pump 630PS) when this is already full. FIG. 35 illustrates this structure.

If the service station carries out a cleaning of the wet cleaning tool, additional dirty water can accumulate, which is collected in a collection container, for example a sump 600w which is located, for example, in the base of the service station, and then pumped out of this sump into the dirty water tank 630 of the station. If this dirty water tank 630 is already full, no more dirty water may be pumped out of the sump 600w into the dirty water tank 630.

It is therefore necessary for the collection container/sump 600w to be at least large enough to hold the amount of liquid required for cleaning the wet cleaning tool. In addition, it should be ensured that the volume of liquid that accumulates when cleaning the wet cleaning tool does not exceed a defined amount, so that the collection container is never filled beyond the capacity limit. To prevent overflow, depending on which device provides the liquid (station and/or robot), either the station (e.g. by measuring water consumption) or the robot can limit the volume of liquid used (e.g. by using only the cleaning fluid from the robot tank, which means that the volume that may potentially occur is limited by the tank volume).

In the event that the station provides the liquid, a sensor can be used to determine the flow rate in order to limit the amount of liquid for cleaning the wet cleaning tool. Suitable flow sensors are known per se and are therefore not discussed further here. Such a sensor could also be used to fill tanks in robots with defined amounts of liquid. For example, after a specified amount of liquid, a valve could close, stopping further supply of liquid. Such a sensor can also be used well when a tank (which of course can also have a vent valve 180LL, cf. FIG. 32b) is completely filled. Despite the vent valve, the pressure in the robot tank increases as the filling increases (due to the compression of the air remaining in the tank). Close to maximum filling or when the liquid reaches the vent valve 180LL, the pressure will increase again significantly and the flow rate will drop significantly if the filling pressure remains constant. This decreasing flow rate can in turn be registered by the above-mentioned sensor, and the valve in the supply pipe 180FL (see FIG. 32b) to the tank 180 can be closed. Alternatively, the tank could also only be filled up to a certain volume with such a sensor. For the complete filling of a tank, a pressure sensor could of course also be used, which can recognize that the tank has been completely filled by detecting an increase in pressure.

In the event that the cleaning fluid from the robot is used to clean the wet cleaning tool, the collection container 600w should, as already mentioned, have at least a volume that corresponds to the volume of the robot tank 180 so that the tank can at least be completely emptied. If the liquid from the tank is used to clean the wet cleaning tool, a corresponding additional safety volume should be provided when using foaming cleaning agents. In order to ensure that the robot does not carry out a cleaning at the service station if the collection container 600w (cf. FIG. 35) is already at its capacity limit, sensors in the robot or in the station can be used to check the filling level of the collection container 600w (e.g. by measuring the fill level in the sump 600w, which can be done by the service station with a float and by the robot with a distance sensor or a reflex optocoupler). A further possibility for ensuring this is that the tank 180 of the robot is only filled up after it has already been ensured that the collection container 600w in the service station has sufficient capacity for any cleaning. If, for example, after the robot has docked at the service station, the tank 180 of the robot is not filled, this can indicate, for example, that the fresh water tank of the station is empty. However, as previously mentioned, it could be an indication of other circumstances, for example as in the case mentioned above that collection tank 600w or dirty water tank 630 is full and needs to be emptied. This means that the service station (or also the robot) can prevent the tank 180 in the robot from being refilled, in particular when it is detected that the collection container 600w and/or the dirty water container 630 is full.

If the robot or the station has appropriate sensors that detect whether the robot tank is being filled, an HMI could also forward this information to the user. Of course, the communication of this situation does not necessarily have to take place via the robot, but could also be signaled by the station and/or sent to an external HMI of the user.

If one considers that the robot uses a certain amount of liquid for the processing of a surface, it can be assumed that the dirty liquid container 630 (see FIG. 35) can have a smaller volume than the fresh liquid container arranged in the service station. With the same total volume, the fresh liquid container in the station can be made correspondingly larger, which leads to less frequent maintenance by the user. Typical station maintenance often involves draining or refilling station tanks and reservoirs. Typically, dirty water (dirty liquid) has to be disposed of and fresh water (fresh liquid) has to be topped up. Often both will be necessary at the same time or the user will do both at the same time for practical reasons. In this case, it makes sense for the two containers for fresh and dirty water to be removed from the service station as a single unit, or taken as a unit to the water disposal point or water refilling point, which are often close together (e.g. the sink in a kitchen). This could be realized, for example, by fitting both in a superordinate containers or by the containers being releasably connected to one another by a lock or other form-fitting mechanical coupling. Depending on the locking position, both containers could then be removed or carried together or individually.

Instead of interlocking, it would also be possible to combine both containers in a superordinate container. A user could then, for example, remove the superordinate container in order to transport it in the living area, but also remove the individual tanks in order to empty or fill them up, for example. Of course, systems without locking or superordinate containers are also conceivable. The containers could be shaped in such a way that the respective carrying areas can also be used individually, as well as common or combinable carrying areas. Furthermore, the containers can also have interlocking structures which, when transported together, prevent or make it more difficult for them to slip in certain directions relative to one another.

The same designs are also possible for dust containers or other containers (e.g. cleaning additives and cleaning agents). These could also be constructed in such a way that they can be removed and transported together with others. The user could then, for example, simultaneously dispose of the dust and, for example, fill up cleaning agents and/or dispose of fresh water or dirty water. In this context, it is pointed out that the fresh liquid container can have a larger volume than the dirty liquid container, since part of the liquid evaporates during the cleaning process (especially when cleaning the floor) and is thus lost.

Also the overall structure of the robot and the design of functional and operating elements allow advantages for the user and the product. As described above, a cleaning robot can be designed in such a way that, during a forward movement, it first cleans the dry cleaning zone or the wet cleaning zone (cf. FIG. 14 and the associated description) the floor surface. As described, the wet cleaning zone can be designed in such a way that it only optionally touches the floor. This could be done, for example, by raising the wet cleaning tool relative to the floor and optionally also in such a way that parts of the wet cleaning tool are covered (cf. FIG. 15, wet cleaning tool 410). In order to prevent a floor from being undesirably wetted with liquid, the robot can also be constructed in such a way that any moisture from a wet cleaning tool collects in one area of the robot and/or that the wet cleaning tool is actively dried.

In order to minimize the distance that the liquid has to cover in the robot, it is advantageous if the tank for the cleaning liquid is positioned as close as possible to the wet cleaning tool. This reduces the area in which undesirable liquid leakage can occur in the event of a fault. It is also useful to have as large a capacity as possible for the liquid tank 180 in the robot (see FIG. 33) in order to enable the processing of the largest possible floor area. In order to equip the wet cleaning tool with a lifting mechanism (see FIG. 32a, lifting mechanism 420HV), it is mechanically advantageous if this is also positioned close to the wet cleaning tool. It is therefore useful if the cleaning tank 180 is at least partially located above or encloses the lifting mechanism. Furthermore, this results in the advantage that the lifting mechanism, tanks and the wet cleaning unit can be located in the rear area of the robot and all standard components of a robot are accommodated in the front area (cf. FIG. 36, the components 180 and 190 are to the right of the vertical axis (dash-dotted line) of the robot). This allows for easier modification of modules during design for the next generation of robots, since some injection molded parts can remain unchanged.

If the robot should also be able to empty its dust collection container 190 at a service station, it is advantageous if this (as mentioned in the rear area) is arranged centrally (in relation to the longitudinal axis of the robot) in the robot housing. The same applies, of course, to a water tank 180, which can e.g. enclose the dust collection container. This structure enables balanced weight distribution and parallel coupling of liquid supply and dust extraction on the robot when docking at the service station. For product-related reasons as well as for aesthetic reasons, both connection points (cf. FIG. 34, interfaces 180KB, 191KB) can lie in the symmetry axis of the robot. Depending on the configuration, a tank or container of the robot can thereby at least partially enclose another tank or container and/or also form or at least partially enclose the connecting pipe 191EV of another tank to the service station.

In this context, it is also advantageous if the lifting mechanism 420HV is implemented in such a way that it is located at least partially below the dust collection container 190 and/or below the water tank 180 and ideally forms a separate assembly that is attached as a whole to the chassis of the robot. In order to ensure a balanced weight distribution of the robot, it makes sense to arrange the motor or motors of the lifting mechanism symmetrically, or to arrange them in such a way that they are symmetrical to other motors (e.g. drive motors of the wet cleaning tool, brush motors of the robot . . . ). For example, the drive of the cleaning tool (in relation to the direction of travel or the longitudinal axis of the robot) could be positioned in the right half of the robot and the motor for the lifting function could be positioned on the left side in such a way that when mirrored around the median plane (perpendicular to the floor through the longitudinal axis of the robot) at least partially intersect their spatial volumes.

Furthermore, it is advantageous if the suction module of the dry cleaning unit (see FIG. 36, item 541) has its center of gravity on the opposite side of the vertical axis (dashed line in FIG. 36, intersects the axis of rotation of the drive wheels) to the water tank (and/or the lifting module or also the dust container) of the robot. In particular, the dry cleaning unit (see FIG. 36, item 541) can have its center of gravity in the half of the robot that does not contain the interfaces 180KB, 191KB to the service station. In this way, the dry cleaning unit and the wet processing unit are spatially separated, which on the one hand leads to less interference between the two units and on the other hand makes repair or service work easier. For example, the robot could be constructed as shown in FIG. 36, in which the center of gravity of the dust container, water tank and/or lifting mechanism as well as the coupling connections to the station are located behind the drive wheels and the center of gravity of the suction module of the dry cleaning unit, is located in front of the drive wheels or on the opposite side.

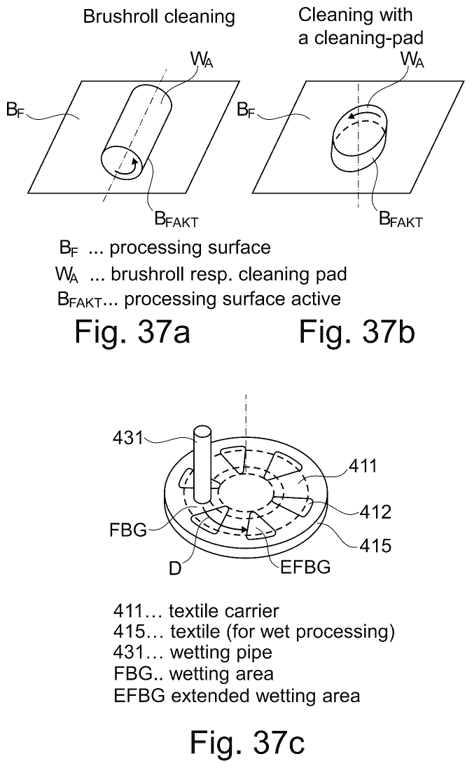

Especially in the case of wet cleaning tools that have a lifting function (lifting device 420HV), it can be advantageous if the wet cleaning tool is positioned in such a way that liquid from the robot tank 180 can moisten the wet cleaning tool both when it is lowered and when it is raised. If the lifting function is designed in such a way that it is approximately vertical, wetting can be achieved, for example, simply by allowing liquid to flow onto the wet cleaning tool, e.g. by gravity, via a valve. In the case of moving wet cleaning tools, this possibility is particularly useful, since in this case a larger area (in FIG. 37c referred to as extended wet wetting area, EFBG) of the wet cleaning tool, can be moistened with a small liquid delivery area (e.g. defined by the end of the wetting pipe 431, denoted by wetting area FBG in FIG. 37c). In the case of rotating wet cleaning tools, it is of particular advantage that water can be applied to the wet cleaning tool over a large angular range and can thus wet it. In such a way a relatively small liquid delivery area (FBG) can thus cover almost the entire wet cleaning tool (EFBG) in one rotation of the wet cleaning tool. This allows the tool to be wetted very quickly. Of course, this applies both to roller-shaped wet cleaning tools (cf. FIG. 37a) whose axes of rotation are approximately parallel to the floor and to wet cleaning tools with an approximately vertical axis of rotation, such as cleaning pads (cf. FIG. 37b).

The contact surfaces BFAKT (see FIG. 37a) of roller-like wet cleaning tools with a vertical axis, however, have a (in relation to the total surface area of the wet cleaning tool) reduced engagement area as compared to the contact surfaces BFAKT (see FIG. 37b) of wet cleaning tools with approximately vertical axes of rotation.

According to the concept described here, it can be advantageous if the liquid is applied to one side (rear side, facing the robot) of the wet cleaning tool and the processing is carried out on the other side of the wet cleaning tool (front side, facing the floor). In this case, it is particularly advantageous if one or more areas of the wet cleaning tool allow the liquid to be applied directly to the wet cleaning textile 415, e.g. the holding structure (i.e. the textile carrier 411) has openings 412 for this purpose, through which the textile can be moistened from above (from the rear side, e.g. in the area between the spokes of a wheel-like support structure of the textile carrier 411 or a water-permeable grid-like structure as a textile carrier 411 as shown in FIG. 37c)

A few exemplary embodiments are summarized below, with the following list not being a complete list but merely an exemplary summary:
1. A system comprising:
   an autonomous mobile robot, which has a tank for cleaning liquid and a wet cleaning unit for wet cleaning using the cleaning liquid and at least one cleaning tool;
   a service station for the robot with a service unit, the robot and the service unit being designed to clean or replace the at least one cleaning tool of the wet cleaning unit; and
   wherein the service station or another service station has a cleaning liquid reservoir and is designed to fill or exchange the tank of the robot.
2. The system according to example 1,
   wherein the robot further comprises a device to control the wetting of the wet cleaning unit with cleaning agent from the tank.
3. The system according to Example 1-2,
   wherein the robot further comprises a dry cleaning unit
4. The system according to example 3,
   wherein the wet cleaning unit is arranged on the robot in such a way that when the robot docks at the service station, the wet cleaning unit is first introduced into the service station.
5. The system according to Example 3-4,
   wherein the wet cleaning unit is arranged on the robot such that after the robot is docked with the service station, the dry cleaning unit of the robot is not affected by the humidity of the wet cleaning unit or the service unit.
6. The system of Examples 3-5,
   wherein the service station includes a fan or exhaust.
7. The system according to example 1 to 6,
   wherein the service unit of the service station and the robot are designed to draw cleaning liquid at least partially from the tank of the robot for cleaning the at least one cleaning tool
8. The system according to example 3-7,
   wherein the cleaning program with which the wet cleaning tool is cleaned is controlled by the robot.
9. An autonomous mobile robot, which has:
   a tank for cleaning liquid and a wet cleaning unit with at least one cleaning tool for wet cleaning of a surface using the cleaning liquid;
   wherein the robot is designed to draw cleaning liquid for cleaning of the cleaning tool from the tank of the robot.
10. The robot according to example 9,
   wherein the robot is designed to apply cleaning liquid from the tank onto the at least one cleaning tool from above.
11. The robot according to example 9 or 10,
   wherein the at least one cleaning tool has channels for conducting the cleaning liquid, which are coupled to the tank or uses channels or grooves for application on the cleaning tool.
12. The robot according to any one of examples 9 to 11,
   wherein the robot is configured to clean the cleaning tool with a moving action, while the cleaning tool touches a surface, in particular a washboard of a service station or a drain area of the floor.
13. An autonomous, mobile robot that has:
   a wet cleaning unit with at least one cleaning tool for wet cleaning a floor surface,
   wherein the at least one cleaning tool is height-adjustable, and
   wherein the robot is designed to raise and lower the at least one cleaning tool in a washing mode, wherein the cleaning tool is flushed with cleaning fluid
14. The robot according to example 13,
   wherein the robot is configured to move the cleaning tool to clean the cleaning tool while the cleaning tool touches the washboard.
15. An autonomous, mobile robot, which has:
   a wet cleaning unit with at least one cleaning tool for wet cleaning a floor surface,
   wherein the at least one cleaning tool is height-adjustable, and
   wherein the robot is designed, in a drying mode, to squeeze out liquid out of the cleaning tool by pressing the cleaning tool against a surface and/or to eject liquid from the cleaning tool by moving the cleaning tool, in particular by alternating rotation of the cleaning tool.
16 The robot according to any one of Examples 13 to 15,
   wherein the robot is configured to, in a drying mode, lift the wet cleaning unit to dry it and, wherein the cleaning tool is moved during the drying.
17. The robot according to any one of Examples 13 to 16,
   further comprising a fan, the robot being configured to dry the cleaning tool by generating an air-flow from the fan onto the cleaning tool.
18. An autonomous, mobile robot, comprising:
   a wet cleaning unit with at least one cleaning tool for wet cleaning a floor surface,
   wherein the at least one cleaning tool is height-adjustable, and
   wherein the robot is configured to detect that it is stuck or cannot overcome obstacles can and if so,
   to switch to an obstacle mode in order to free itself or to overcome obstacles, by moving the at least one cleaning tool, in particular by raising and lowering it.
19. The robot according to any one of examples 13 to 18,
   wherein the robot is configured to lift the at least one cleaning tool before entering a service station.
20. An autonomous mobile robot, comprising:
   a wet cleaning unit having one or more cleaning tools for wet cleaning a floor surface;
   and a dry cleaning unit for dry cleaning of the floor surface,
   with the dry cleaning unit being arranged in front of the wet cleaning unit with respect to a travel direction of the robot during a cleaning process,
   and with the dry cleaning unit and the wet cleaning unit not being arranged overlapping on the robot, so that when the wet cleaning unit is cleaned, the dry cleaning unit is not wetted.
21. An autonomous mobile robot, comprising:
   a wet cleaning unit with one or more rotatable cleaning tools for wet cleaning of a floor surface;
   and a dry cleaning unit for dry cleaning of the floor surface,
   wherein the dry cleaning unit is arranged in front of the wet cleaning unit with respect to a travel direction of the robot during a cleaning process, and
   wherein the dry cleaning unit and the wet cleaning unit are arranged on the robot in a non-overlapping manner, wherein during a cleaning process in which a floor surface is cleaned using the wet cleaning unit, no cleaning liquid reaches the dry cleaning unit.
22. The robot according to example 20 or 21,
   wherein a housing part of the robot forms a barrier between the dry cleaning unit and the wet cleaning unit, so that no liquid can get from the wet cleaning unit to the dry cleaning unit.
23. An autonomous mobile robot comprising:
   a wet cleaning unit with one or more rotatable cleaning tools for wet cleaning a floor surface,
   a drive for raising the wet cleaning unit or the cleaning tools so that the cleaning tools no longer touch the floor;
   wherein the robot is designed to carry out a drying process in which the wet cleaning tools are moved in the raised state.
24. The robot according to example 23,
   wherein the drive for lifting the wet cleaning unit also causes the rotational movement for the cleaning tools.
25. An autonomous, mobile cleaning robot (100), comprising:
   a housing (101),
   a wet cleaning tool (410) arranged on the underside of the housing;
   and a moveable cover (415) on the underside of the robot configured to cover and uncover the wet cleaning tool (410).
26. The cleaning robot according to example 25,
   wherein the movable cover (415) covers the wet cleaning tool (410) such that liquid from the wet cleaning tool (410) is collected in a reservoir.
27. The cleaning robot according to example 25 or 26,
   wherein the cleaning robot is designed to calculate a fill level of the reservoir based on a period of time that the cover covers the wet cleaning tool (410), or
   wherein the cleaning robot is designed to calculate a fill level of the reservoirs based on a quantity of liquid previously supplied to the wet cleaning tool, or
   wherein a fill level sensor is arranged in the reservoir and the cleaning robot is designed to measure the fill level of the reservoir using the fill level sensor.
28. The cleaning robot according to example 27,
   wherein the cleaning robot is designed to carry out one of the following actions when the filling level reaches a predefined value:
   using the liquid collected in the reservoir for wet cleaning;
   disposing of the liquid collected in the reservoir at a service station;
   evaporating the liquid collected in the reservoir;
   Pumping the liquid collected in the reservoir back into a tank from which the liquid can be returned to the wet cleaning tool.
29 The cleaning robot according to any one of examples 25 to 28,
   wherein the cover (415) is formed by a film. [cables, inflate]
30. The cleaning robot according to any one of examples 25 to 29,
   wherein the cleaning robot has a drive for the wet cleaning tool (410) and wherein the cover can be coupled to the drive so that the cover can be displaced using the drive.
31. The cleaning robot according to any one of Examples 25 to 30,
   wherein the robot has a heater for drying the wet cleaning tool.
32. An arrangement comprising:
   a service station for an autonomous mobile cleaning robot with a service parking space for the cleaning robot into which the robot can drive from a front of the arrangement;
   a tank (640) accessible to a user from the front or connections for an external tank.
33. The assembly of example 32,
   wherein the assembly has a front housing cover that can be moved to access a tank.
34. The arrangement according to example 32,
   wherein the housing cover is formed by a wall of the tank.
35. The service station according to example 34,
   wherein the housing cover has a mounting device (661) for a panel. [built-in device]
36. The arrangement according to one of the examples 32 to 35,
   wherein the tank contains cleaning liquid or other consumables.
37. The assembly of any of Examples 32 to 36,
   wherein the assembly includes multiple tanks.
38. The arrangement according to any one of examples 32 to 37, further comprising:
   a water treatment system for purification of dirty water.
39. The arrangement according to any one of examples 32 to 38, further comprising:
   Tanks with their own housing, which are connected to the connection points and contain cleaning liquid or other consumables.
40. An arrangement comprising:
   a household appliance; and
   a service station according to any of Examples 32 to 39,
   wherein the service station is integrated into a housing of the household appliance.
41. A service station for an autonomous, mobile robot, which comprises the following:
   a first pipe, via which a tank arranged in the robot can be filled with a first consumable, in particular liquids, and
   a container that can accommodate a second consumable (620) for the autonomous mobile robot, and
   a device configured to mix the first consumable from the first container and the second consumable from the second container, or
   a device configured to fill an autonomous mobile robot with the first consumable from the first container and the second consumable from the second container.
42. A service station according to example 41,
   with a service parking space for the cleaning robot, into which the robot can drive from a front of the arrangement;
   and a tank for a second consumable (620) accessible to a user from the front.
43. The service station according to example 41 or 42,
   wherein the service station has an assembly device for a panel (built-in device).
44. The service station according to one of examples 41 to 43,
   wherein the second consumable (620) is one of the following:
   cleaning concentrate and/or
   decalcifying agent and/or
   disinfecting substances, in particular of the fungicidal, antibiotic, and/or antiviral kind.
45. The service station according to one of examples 41 to 68, which comprises the following:
   a device for disinfecting liquids using electromagnetic radiation, in particular UV light.
46. The service station according to any one of examples 41 to 45,
   wherein the service station is designed to measure a fill level of the second consumable in the container, or
   to calculate it based on consumption during operation and
   to make the fill level available on an HMI or
   to inform the user that the second consumable is to be refilled when the fill level falls below a certain level and/or
   to send a message to a user or an ordering service.
47. The service station according to any one of examples 41 to 46,
   wherein the service station uses the mixture of the first and second consumables
   to clean the interior of the service station or
   to clean the robot or
   to introduce it into a tank of the cleaning robot.
48. Service station for an autonomous mobile robot according to example 47,
   wherein the mixing ratio of the first and second consumable depends on the area in which the robot performs a service task with this consumable.
48. The service station according to any one of examples 41 to 47,
   wherein the service station uses the mixture of the first and second consumables for different cleaning modes,
   the modes differing by at least one of the following parameters:
   duration of cleaning
   mixing ratio of the first and second consumables
   temperature of the mixture of the first and second consumables
49. A system comprising an autonomous mobile robot and a service station,
   the service station having a first pipe, via which a tank arranged in the robot can be supplied with a liquid, and a second pipe, via which the tank can be connected to a drain of the service station; and
   wherein the service station is designed to flush the tank of the robot with liquid from the liquid supply in a cleaning mode.
50. The system of example 49,
   wherein the service station is configured to heat and/or pressurize the liquid used for cleaning.
51. A service station for an autonomous mobile robot, comprising:
   a cleaning unit configured to clean a part of the robot other than the cleaning tool, in particular an outer surface of the robot.
52. The service station according to example 51,
   wherein the service station has a cleaning tool for cleaning the robot, which comprises one of the following:
   textiles attached in the station,
   brushes attached in the station,
   nozzles, attached in the station, for cleaning fluid, in particular air or/or cleaning liquid.
53. A system comprising an autonomous mobile robot and a service station,
   wherein the service station has at least one element inside it which can interact with at least one sensor of the robot when the robot is in the service station, and
   wherein the robot and/or the Service station are designed to test the sensor of the robot with the help of the element.
54. The system according to example 53,
   wherein the element is a marker, in particular an optical marker, a device for generating an optical marker or a mirror, and
   wherein the sensor of the robot is a visual sensor.
55. The system according to example 53 or 54,
   wherein the element is an indentation in a surface of the service station or mechanical stop,
   wherein the sensor of the robot is an optical sensor, a distance sensor or a contact switch.
56. The system according to any one of examples 53 to 55,
   wherein the element comprises an actuator configured to release a part connected to the robot, and
   wherein the sensor of the robot is a sensor that detects the release or the reconnection of the part.
57. Service station for an autonomous mobile robot according to example 53 to 56,
   wherein the element is a mechanical apparatus which is designed to decouple a component of the robot in order to check sensors which are designed to detect to the presence of said component—or its being connected or disconnected.
58. Service station for an autonomous mobile robot according to example 53 to 57,
   wherein the element is a mechanical apparatus which is designed to apply a mechanical resistance to a moving component of the robot in order to test a current or voltage sensor of a drive unit of the component.
59. The system according to any one of examples 53 to 58,
   wherein a user command result in the robot performing a self-diagnosis of the sensors and, if available, also driving into a service station and performing the diagnosis there.
60. The system according to example 59,
   wherein in the event of an unsatisfactory self-diagnosis, if available, a service station is driven into and the robot is cleaned.
61. The system according to any one of examples 53 to 60,
   wherein a calibration of at least one sensor is performed in the event of an unsatisfactory self-diagnosis.
62. A procedure that includes:
   Receiving user input through an HMI for an autonomous mobile robot or its service station.
   Checking whether it is possible for the robot to exit from the service station and, if so,
   approaching a defined target point by the robot.
63. A method according to example 62,
   wherein the defined target point is at a specific distance from the service station and is on a trajectory that the robot follows when leaving the service station.
64. A method according to example 62 or 63,
   wherein the defined target point is modified if the defined target point cannot be approached. Especially when there is an object at the target point.
65. A method according to any one of Examples 62 to 64,
   wherein the defined target point is calculated by the controller of the robot based on the map information.
66. A method according to one of the examples 63 to 65,
   wherein when searching for a target point only points are selected which maintain a minimum distance from obstacles.
67. A method according to one of examples 63 to 66,
   wherein the defined destination can be freely configured by the user on the map.
68. A method according to any one of examples 63 to 67,
   wherein the robot enters a service mode in which the drives are switched off and the robot displays its status or sends its status to an HMI.
69. An autonomous, mobile robot, comprising:
   a drive system,
   a control unit that controls the drive system,
   a cover that covers the control system,
   the cover being shaped in such a way that liquid coming from above cannot flow into the control system.
70. An autonomous, mobile robot according to example 69,
   wherein the control unit is located in a cavity which is hermetically separated from the environment by seals.
71. An autonomous, mobile robot according to example 69 or 70,
   wherein the robot has a tank.
72. An autonomous mobile robot according to any one of examples 69 to 71,
   wherein the housing is shaped such that liquid coming from above collects in a tank.
73. An autonomous, mobile robot according to any one of examples 69 to 72,
   wherein the tank cannot be removed from the robot.
74. An autonomous, mobile robot according to any one of examples 69 to 73,
   wherein the robot has a valve that can be used to select whether the liquid coming from above is collected in a tank or channeled past it.
75. An autonomous, mobile robot according to any one of examples 69 to 74,
   wherein the robot has a valve which can be used to select whether liquid in the tank can be drained off or left in the tank.
76. An autonomous, mobile robot according to any one of examples 69 to 75,
   wherein the robot can suck air through the tank and dirt is deposited on a sieve or filter.
77. An autonomous, mobile robot according to any one of examples 69 to 76,
   wherein the robot has a sieve that can be removed for cleaning.
78. An autonomous, mobile robot, comprising:
   a first container for a first consumable and
   a second container for a second consumable and
   a device which is configured to mix the first consumable from the first container and the second consumable from the second container.
79. The robot according to example 78,
   wherein the robot is designed to estimate the required amount of the second consumable before starting a cleaning process and to fill up the second container to the required amount at a service station.
80. The robot of example 78 or 79,
   wherein the first and second consumables have different temperatures and the robot is configured to mix the first and second consumables so that the resulting mixture has a certain temperature.
81. The robot according to any one of examples 78 to 80,
   wherein the second container is thermally insulated.
82. The robot according to any one of examples 78 to 81,
   wherein the robot has a heater configured to heat the first or second consumable or to keep it at a certain temperature.
83. The robot according to any one of examples 78 to 82,
   wherein the robot is configured to adjust the mixing ratio of the first and second consumables depending on the location where the service task is to be fulfilled.
84. A system comprising an autonomous, mobile robot and a service station,
   the robot having two interfaces with the same functionality for coupling to two different types of service stations, or
   the service station having two interfaces with the same functionality for coupling to two different types of autonomous, mobile robots.
85. The system of example 84,
   wherein the two interfaces are both configured to exchange the same material or to exchange electrical power or information.
86. A system comprising an autonomous, mobile robot and a service station,
   both the robot and the service station having two or more interfaces on corresponding side surfaces for the exchange of different materials, the robot and the service station being constructed in such a way that in the course of a docking movement of the Robot in the direction of the service station, the interfaces are coupled, and
   the interfaces are coupled exclusively only due to the docking movement of the robot and have no parts being moved by a drive themselves.
87. The system according to example 87,
   whereby the interfaces can be in a coupled state simultaneously at the same time.
88. The system of example 86,
   wherein the corresponding side surfaces of the robot and service station are opposite each other during the docking movement and have a normal vector that is approximately parallel to a direction of the docking movement.
89. The system according to any one of examples 86 to 88,
   wherein the different materials comprise at least one liquid and one solid, in particular dust.
90. The system according to one of examples 86 to 89,
   wherein both the robot and the service station have at least one further interface for the transmission of electrical energy and/or information on the corresponding side surfaces.
91. The system of example 90,
   wherein the electrical energy transfer interface comprises contacts located over the fluid interface.
92. The system according to any one of examples 86 to 91,
   wherein the robot and service station have corresponding mechanical elements on the corresponding side surfaces which enable an exact alignment of the corresponding side surfaces relative to one another during docking.
93. The system according to example 92,
   wherein the mechanical element is part of one of the interfaces for the exchange of different material.
94. The system of example 93,
   wherein the mechanical element is part of the interface that has the greatest requirement for leak tightness.
95. The system according to any one of examples 86 to 94,
   wherein the robot and service station are designed to be interlocked to one another.
96. The system according to any one of examples 86 to 95,
   wherein at least one of the interfaces for material exchange is provided with a sealing element for sealing the connection between the robot and the service station when the robot is coupled, which in the uncoupled state seals the part of the interface located on the robot or on the service station.
97. An autonomous mobile robot, which comprises the following:
   a tank for a liquid,
   an interface to a service station on a side surface of the robot, which is connected to the tank via a connecting pipe,
   the connecting pipe being shaped such that when the tank is filled to a first level, liquid cannot spill via the inlet at the interface,
   the inlet of the interface being located below the first level.
98. The robot of example 97,
   wherein the inlet has a seal.
99. An autonomous mobile robot, comprising:
   a first container and a second container, and
   a connecting pipe for connecting the first container to an interface on the outside of the robot for docking with a service station,
   wherein a section of the connecting pipe is at least partially surrounded by the second container.
100. The robot according to example 99,
   wherein the section of the connection pipe is formed by a wall of the second container.
101. The robot according to example 99,
   wherein either the first reservoir or the connecting pipe has a flap which closes the reservoir or the connecting pipe, respectively,
   the flap being designed to open when a partial vacuum is applied to the interface.
102. A system comprising an autonomous, mobile robot and a service station with an interface for exchanging electrical energy, which is also designed to exchange information, the interface enabling direct electrical contact between the robot and the service station or a wireless connection.
103. The system according to example 102, wherein the information exchanged comprises at least one of the following: status reports of the robot or the service station, at least parts of a work order of the robot or a service function of the service station.
104. The system of example 102 or 103, further comprising:
   a human-machine interface for outputting at least a portion of information transmitted between the robot and the service station.
105. The system according to one of examples 102 to 104,
   wherein the robot and/or the service station is designed to carry out a plausibility check of sensor values based on information exchanged via the interface, where the values have been recorded by sensors in the robot or in the service station.
106. A method for an autonomous mobile robot, comprising:
   coupling the robot to a service station, wherein a container arranged in the robot is connected to the service station via a pipe;
   measuring a flow rate through the pipe and/or a pressure in the pipe by means of one or more sensors in the service station,
   determining a filling level of the container or detecting when a filling level has been reached from the values supplied by the sensors in the service station.
107. A method for an autonomous mobile robot, comprising:
   coupling the robot to a service station, wherein a container arranged in the robot is connected to the service station via a pipe;
   detecting, using a sensor in the robot, whether liquid flows through the pipe into the container in the robot,
   if it is detected that no liquid flows into the container in the robot,
   sending a message to a user via a man-machine interface that a liquid tank in the service station needs maintenance.
108. A service station for an autonomous mobile robot, comprising:
   a dirty fluid reservoir, and
   a fresh fluid reservoir that is larger than the dirty fluid reservoir.
109. A service station for an autonomous mobile robot, comprising:
   two or more containers for particles and/or liquids;
   wherein at least two of the containers are mechanically coupled and designed such that they can be removed together from the service station,
   and wherein the mechanical coupling can be released so that the containers can optionally be removed individually from the service station.
110. The service station according to example 109,
   wherein the mechanical coupling is achieved by arranging the at least two containers in a further container.
111. The service station according to example 109,
   wherein the mechanical coupling is brought about by a form-locked arrangement of the at least two containers on one another or by a detachable latching or snap connection.
112. An autonomous mobile robot, comprising:
   at least one container for cleaning liquid or dust particles;
   a wet cleaning device and
   a lifting device for raising and lowering the wet cleaning device, wherein the lifting device is arranged at least partially below the container or wherein the lifting device is at least partially encased by the container.
113. An autonomous mobile robot, comprising:
   a wet cleaning device and
   a lifting device for raising and lowering the wet cleaning device,
   the lifting device having a motor arranged on a first side, right or left, with respect to the direction of travel of the robot, and
   a further drive is arranged on the respective other side.
114. The robot according to example 113,
   wherein the drive of the lifting device occupies a first volume in the robot housing and the further drive occupies a second volume in the robot housing,
   the first volume overlapping with a third volume, which is generated by mirroring the second volume around a median plane;
   the median plane is parallel to a traveling direction of the robot and normal to a floor surface through the center of the robot.
115. A method for an autonomous mobile cleaning robot, comprising:
   Application of liquid from a tank of the cleaning robot to a rear side of a wet cleaning tool, with a front side of the wet cleaning tool touching a floor surface during a cleaning process.
116. The method of Example 115,
   wherein the wet cleaning tool is in the form of a rotating disk that rotates about an axis of rotation normal to the floor surface.
117. The method according to example 115 or 116,
   wherein the cleaning tool has a textile carrier (411), on the front side of which a textile for cleaning the floor surface is arranged,
   wherein the textile carrier (411) has openings, and the liquid is applied to the textile carrier in the region of the openings.

### Old Claims 2nd Registration

118. A service station for an autonomous mobile robot, comprising:
   a cleaning unit designed to clean a cleaning tool or another part of the autonomous mobile robot, and
   a wastewater connection for disposing of liquid into the public waste water system.
119. The service station according to example 118,
   wherein the cleaning unit uses a cleaning liquid for cleaning, which can be disposed of via the wastewater connection into the public wastewater system.
120. The service station according to claim 1 or 2, further comprising:
   a connector for connecting the service station to a fresh water supply system or a fresh water tank.
121. The service station according to one of claims 1 to 3,
   wherein the service station is designed to empty a dirt collection container of the robot and to dispose of its contents at least partially via the sewage system.
122. The service station according to any one of claims 1 to 4, further comprising:
   an air dehumidification system which is designed to extract water from the ambient air,
   wherein the service station is designed to make available the water extracted from the air to the cleaning unit.
123. The service station according to any one of claims 1 to 5, further comprising:
   a connection for a waste water collection tank,
   wherein the cleaning unit uses a cleaning liquid for cleaning, which can be disposed of in the waste water collection tank.
124. The service station of any one of claims 1 to 6, further comprising:
   a cleaning fluid recycling system.
125. The service station according to one of claims 1 to 7, which further comprises:
   an analysis unit which is designed to analyze the dirty water collected in the service station with regard to the degree of pollution and/or with regard to its chemical composition.
126. The service station of any one of claims 1 to 8, further comprising:
   an air cleaning unit configured to clean ambient air.
127. A system, comprising:
   a household appliance having a sewage connection for connecting the household appliance to a sewage network; and
   a service station for an autonomous mobile robot according to any one of the claims 1 to 9
   the wastewater connection of the service station being indirectly coupled to the sewage network via the wastewater connection of the household appliance.
128. A service station for an autonomous mobile robot (100), comprising:
   a housing (600) having a gate (600T);
   a parking position arranged inside the housing (600), which the robot (100) can reach through the gate (600T), and
   wherein the service station is designed to accept particles and/or liquids from the robot (100) at the parking position.
129. The service station of claim 11,
   wherein the gate (600T) is part of an elevator system configured to lift the robot (100) into the housing.
130. The service station of claim 11 or 12,
   wherein the gate (600T) is mechanically coupled to at least one mechanical actuator such that the gate (600T) opens or closes when the robot (100) touches the actuator.
131. The service station according to any one of claims 11 to 13,
   wherein the gate has a sealing element (600TD) so that the housing (600) is watertight when the gate (600T) is closed.
132. The service station of any one of claims 11 to 14, further comprising:
   adjustable feet (800F) for the housing (600) for leveling the service station.
133. The service station of claim 15,
   wherein the feet (800F) include active or passive dampers.
134. The service station of any one of claims 11 to 16, further comprising:
   a base or sump (600w) at the robot's parking position.
135. The service station according to one of claims 11 to 17,
   wherein the housing (600) is sealed tight when the gate (600T) is closed, so that liquids can only drain off via a drain provided for this purpose and/or liquids can only flow in via a feed provided for this purpose.
136. The service station according to any one of claims 11 to 18,
   wherein a movable part (600m) of the service station on which the parking position is located can be at least partially pulled out of the housing (600).
137. The service station according to any one of claims 11 to 19,
   wherein the movable part (600m) of the service station has an outlet for wastewater and/or an outlet for cleaning liquid or steam.
138. The service station according to any one of claims 11 to 20, further comprising:
   an operating element, wherein the service station is designed to instruct the robot to leave the service station when the operating element is actuated by a user.
139. The service station according to one of claims 11 to 21, which is designed as a built-in device in that the service station and/or the has a mounting device for a panel and/or for mounting the service station in a piece of furniture.
140. The service station according to any one of claims 11 to 22,
   wherein the service station does not exceed an installation height of 12 cm, and/or
   wherein the service station does not exceed an installation width of 60 cm, and/or
   wherein the service station does not exceed an installation depth of 60 cm.
141. A system comprising:
   a service station according to any one of claims 11 to 23, and
   a garbage collection system (800) coupled thereto,
   wherein the service station and garbage collection system (800) are designed as built-in devices in that the service station and the garbage collection system (800) respectively have a mounting device for a panel and/or have a mounting device for mounting in a piece of furniture.

The examples summarized above have various different aspects and technical features that can be combined to create more embodiments.

1. An arrangement comprising:
a service station for an autonomous mobile robot having a service parking space for the robot into which the robot can drive from a front of the assembly;
one or more tanks accessible to a user from the front of the service station, or a port for connecting the service station to an external tank.

2. The arrangement of claim 1, wherein the assembly includes a front housing cover that can be moved such that the tank becomes accessible.

3. The arrangement of claim 2, wherein the front housing cover is formed by a wall of the tank.

4. The arrangement of claim 2, wherein the front housing cover has a mounting possibility for a trim covering of a built-in device.

5. The arrangement of claim 1, wherein the tanks contain cleaning liquid or other consumables.

6. The arrangement of claim 1, wherein the tank of the service station is adapted to receive particles and/or liquids from the robot.

7. The arrangement of claim 1, wherein the tank further comprises a plurality of tanks.

8. The arrangement of claim 1, further comprising a water treatment system for purification of waste water.

9. The arrangement of claim 7, wherein the tanks include a housing and connection points to connect the tanks to the robot, wherein the tanks contain cleaning liquid dispensed to the robot or receive particles and/or liquids from the robot.

10. The arrangement of claim 1, wherein the tank is part of the service station.

11. An arrangement comprising:
a home appliance; and
a service station,
wherein the service station is integrated into a housing of the household appliance.

12. An arrangement of claim 11, further comprising a cleaning unit which is designed to clean a cleaning tool or another part of the autonomous mobile robot,

13. An arrangement of claim 11, further comprising:
a waste-water connection for discharging liquid into the public sewage system.

14. The arrangement according to claim 12, wherein the cleaning unit uses a cleaning liquid for cleaning, collects the used cleaning liquid, and disposes the used cleaning fluid via the waste water connection into a public sewage system.

15. The arrangement according to claim 11, further comprising a connection for connecting the service station to a fresh water supply system or an external fresh water tank.

16. The arrangement of claim 11, wherein the service station is designed to empty a dirt collection container of the robot and to dispose of its contents at least partially via the sewage system.

17. The arrangement of claim 11, further comprising:
an air dehumidification system which is adapted to extract water from the ambient air,
wherein the service station is designed to provide the water extracted from the air to the robot or to the cleaning unit.

18. The arrangement of claim 11, which further comprises a connection of the service station to an external waste water collection tank, wherein the robot or the cleaning unit uses a cleaning fluid for cleaning, collects the used cleaning fluid, and disposes the used cleaning fluid as waste water in the waste water collection tank.

19. The arrangement of claim 18, further comprising a cleaning fluid recycling system.

20. The arrangement of claim 18, which further comprises an analysis unit which is designed to analyze the waste water collected in the service station with regard to the degree of pollution and/or with regard to its chemical composition.

21. The arrangement of claim 11, further comprising an air cleaning unit configured to clean ambient air.

22. An arrangement of claim 11, further comprising:
a household appliance having a waste water connection for connecting the household appliance to a sewage system;
and wherein the service station has a connection for a waste water system, which is indirectly coupled to the sewage system via the waste water connection of the household appliance.

23. An arrangement of claim 11, further comprising:
a human-machine interface for receiving a user input by an autonomous mobile robot or its service station and transmitting the user input to the robot,
wherein the user input contains a command for the robot that causes the robot to undock from the service station and drive to a defined point.
